(19) United States
(12) Patent Application Publication
(10) Pub. No.: US 2005/0066069 A1
(43) Pub. Date: Mar. 24, 2005

(54) Personal computer control system using portable memory medium and portable telephone set, and portable memory medium and portable telephone set therefor

(76) Inventor: Kenichi Kaji, Kanagawa (JP)

Correspondence Address: STRAUB & POKOTYLO, 620 TINTON AVENUE, BLDG. B, 2ND FLOOR, TINTON FALLS, NJ, 07724, US

(21) Appl. No.: 10/943,572

(22) Filed: Sep. 17, 2004

(30) Foreign Application Priority Data
Sep. 19, 2003 (JP) 328372/2003
Dec. 1, 2003 (JP) 401862/2003
Jan. 16, 2004 (JP) 009382/2004

(51) Int. Cl. G06F 3/00

(52) U.S. Cl. 710/1

(57) ABSTRACT

A portable memory medium storing a specific control program for starting and controlling predetermined application program is loaded o inserted to or in a personal computer. Then, a specific control program is started to cause a user authentication process with respect to the portable memory medium and start the predetermined application program. At the time of the end of the application program control, the data at the time of the end is stored in the portable memory medium, as well as the portable memory medium with the specific control programs stored therein. The portable telephone set may act as the similar operation with the portable memory medium loaded thereto.

### BACKGROUND OF THE PRESENT INVENTION

This application claims benefit of Japanese Patent Application Nos. 2003-328372, 2003-401862 and 2004-009382 filed on Sep. 19, 2003, Dec. 1, 2003, and Jan. 16, 2004, respectively, the contents of which are incorporated by the reference.

The present invention relates to personal computer control systems using portable memory media or portable telephone set.

In project activities, culture activity, educational activities and all other activity fields, computers (personal computers) are indispensable, and needs for operations with personal computers are increasing irrespective of the place. Also, a variety of application programs for executing operations with personal computers are installed therein, and the application programs has to be installed in the personal computers at the operating or working sites.

Under these circumstances, the user operating the personal computer encounters the following problem in the utility aspect.

Recently, the increase of the range of personal computer operations and the quantity of data obtained as a result of the operations inclusive of the field of image processing is pronounced, and these data are stored in a hard disc (HDD) provided in the personal computer. Thus, for use of these data, the user should use the personal computer with the HD storing these data.

In the meantime, the main personal computer is usually located or installed in the company or the own home, but there are many cases, in which operations in places other than the company or the own home, for instance the destination of dispatch or getting out of home. In such cases, a note type personal computer as the main personal computer can be carried along, but nevertheless doing-so is rather cumbersome weight-wise. Furthermore, limitations are imposed on the capacity of the internal memories, and also such problems arise that the use of the printer and other peripheral apparatuses is disabled.

Still further, in company and like organizations one personal computer is often necessary for each employee, but there are many cases, in which it is inevitable in the budget aspect that one personal computer is commonly used by a plurality of persons. In such cases, such a special process as assigning the user IDs of the plurality of users to one personal computer and setting passwords is necessary. This also applies to the case of leased personal computer, and like problems arise in the case of using one personal computer by a plurality of persons for the rental fee saving.

Yet further, it is possible to store the data obtained by operations in such portable memory medium as a floppy disc or an MO and execute operations by using a personal computer at an working or operation site other than the main personal computer site. In this case, however, a problem arises that it is necessary to install in advance the application program used for the operations.

Further, when it is desired to send estimation data or material data to a remote place, a portable memory medium storing data is transported, but the memory medium in which important and confidential data is stored may be lost during the transport. This is a problem in the reliability aspect. A means of E-mail transmission is also considered for sending the data to the destination. In this case, although no problem arises when the E-mail transmission is executed from the main personal computer, E-mail transmission using a different personal computer or a personal computer installed under such hot service provision circumstances such as airports, fast food shops and internet coffee shops, poses significant problems in the security aspect. That is, although the E-mail data may have been apparently deleted, the transmitted data remains in the personal computer, and it is impossible to secure security.

A control system of such a fashion has been in practical use, that the main personal computer (i.e., host personal computer) is connected to an internet or like communication line for its accessing by operation from an external personal computer (i.e., client personal computer) LAN connected via the communication line and utilizing data stored in the internal HD in the host personal computer.

Realization of so-called “ubiquitous” environment, in which various apparatuses such as portable electronic apparatuses and household data apparatuses are connected to the network and can be utilized at any time and in any place, is in steady progress in various fields. Among such progresses, the utilization of the personal computer is most important for the user, and outstanding development such communication network as wireless LAN provides for further convenience.

Even where the “ubiquitous” environments as noted above are provided, a user who operates a universal personal computer in such environments feels various utility aspect inconveniences.

For example, the data obtained with the main personal computer used in the company or own home, are very great in quantity inclusive of image data, and are stored in an internal hard disc, thus imposing limitations on operations with the universal personal computer. Since a large variety of application programs are utilized in the main personal computer, they are difficult to be utilized in the universal personal computer.

In this concern, a note type personal computer as the main personal computer can be directly carried along, but nevertheless doing so is rather cumbersome weight-wise, and also operability problems are posed.

Moreover, although the data obtained with the universal personal computer have been apparently deleted at the end of operation, they are not perfectly removed inclusive of E-mail data from the personal computer, thus leaving the security problem.

### SUMMARY OF THE PRESENT INVENTION

An object of the present invention, accordingly, is to provide a personal computer control system using a portable memory medium, capable of ensuring security without use of a particular personal computer, and also the portable memory medium.

Another object of the present invention is to provide a personal computer control system using a portable memory medium, which permits use of application program to be utilized, preliminarily installed in a personal computer, a server or a portable memory medium with ensured security, and the same portable memory medium therefor.

A further object of the present invention is to provide a personal control system using a portable memory medium, which provides hot services in airports, fast food shops, internet coffees, etc. and permits use of a personal computer in any place so long as environments permitting use of internet are present, and the portable memory media therefor.

A still further object of the present invention is to provide a personal computer control system using a portable memory medium, which can be used by setting operation environments peculiar to the user under secured security condition, and the portable memory medium therefor.

A yet further object of the present invention is to provide a personal computer control system using a portable memory medium, which permits direct use of host personal computer utilization environments at any time and in any place, and the memory medium therefor.

A still another object of the present invention is to provide a personal computer control system using a potable memory medium, in which the “off”-state power supply of a host personal computer can be turned on under control from a client personal computer for using the host personal computers thus contributing to power saving, and the memory medium therefor.

A yet another object of the present invention is to provide a personal computer control system using a portable memory medium, in which the security between a client personal computer and host personal computer is improved, and the memory medium therefor.

A further object of the present invention is to provide a personal computer control system using a portable memory medium, which permits utilizing host personal computer utilization environments while securing the security, and the memory medium therefor.

A further object of the present invention is to provide a personal computer control system using a portable telephone set, which can secure security without preamble of the use of any particular personal computer and permits easily realizing “ubiquitous” environments, and the portable telephone set therefor.

A further object of the present invention is to provide a personal computer control system using a portable telephone set, which can secure security while permitting the start and control of a host personal computer and can easily obtain “ubiquitous” environments, and the same potable telephone set.

According to an aspect of the present invention, there is provided a personal computer control system using portable memory medium, wherein in response to loading or inserting of the portable memory medium to or in a personal computer to be used, a specific control program stored in the portable memory medium for starting and controlling predetermined application program is started, a user authentication process with respect to the portable memory medium is executed, then a predetermined application program stored in the portable memory medium is started, and at the end of the application program the data at the time of the end is stored in the portable memory medium.

The predetermined application program is installed in the personal computer to be utilized. The predetermined application program is installed in a different personal computer from the personal computer to be utilized, connected via a communication medium. The predetermined application program is prepared in a server connected via the internet. The portable memory medium has a port lock function. The specific control program is arranged to prohibit operation by copying in a different memory medium. The password for the authentication is enciphered. As soon as start is executed with the specific control program, unlike the desk top display in the personal computer to be used, a work table including icons of application program controlled by the specific control program is displayed, and the personal computer operation is executed by icon operation on the work table. When the portable memory medium is removed from the personal computer during the personal computer operation, the operation data at this time is stored in the portable memory medium on the basis of an instruction from the user. The portable memory medium is either a USB memory, a CD, a DVD, a MO disc, a flash memory, a memory card or a hard disc.

According to another aspect of the present invention, there is provided a portable memory medium capable of being loaded in a personal computer to be used, wherein specific control programs stored in the portable memory media for starting and controlling predetermined application program, operating a predetermined application program stored in the portable memory media through a user authentication process with respect to the portable memory medium and storing data at the end time of operation of the application program.

A port lock function is provided. The specific control programs are arranged to prohibit operation by copying in a different memory medium. The password for the authentication is enciphered. A program is provided that with the start executed on the basis of the specification control program, unlike the desk top display of the personal computer to be utilized, a work table including icons for application program controlled by the specific control programs is displayed, and the personal computer operation is executed with icon operation on the work table. A program is provided that when the portable memory medium is removed from the personal computer during the personal computer operation, the operation data at this time is stored in the portable memory medium on the basis of an instruction from the user. The portable memory medium is a USB memory, and, a flash memory, a memory card or a hard disc

According to other aspect of the present invention, there is provided a personal computer control system using portable memory medium for controlling a host personal computer connected via a communication line from a client personal computer connected to the communication line, wherein: in response to the loading, in the client personal computer, of a portable memory medium, which the user is allowed by authentication to use, a predetermined program of the client personal computer is started for starting and controlling the host personal computer.

According to still other aspect of the present invention, there is provided a personal computer control system using portable memory medium for controlling a host personal computer connected to a communication line from a client personal computer connected to the communication line, wherein: in response to the loading, in the client personal computer, of a portable memory medium, which the user is allowed by authentication to use, a predetermined program of the client personal computer is started, the state of the host personal computer is monitored, when the power supply thereof is “off”, the power supply is turned on to start and control the host personal computer.

Data exchanged between the client personal computer and the host personal computer is enciphered. The data sent out from the client personal computer is instruction data inputted from an input means, and data sent out from the host personal computer is differential data with respect to immediately preceding sent-out data. At the time of ending the use of the host personal computer the final process data is stored in the portable memory medium. The start of the host personal computer is made possible after completion of authentication in the portable memory medium, authentication in the client personal computer and authentication in the host personal computer. The portable memory medium is either a USB memory, a NO disc, a flash memory, a memory card or a floppy disc. The client personal computer is a portable terminal.

According to further aspect of the present invention, there is provided a portable memory medium, wherein a program is stored for executing, in response to the loading in the client personal computer, a process of checking whether the use by a particular user is allowed and a process of prescribing an operation of controlling the host personal computer connected via a communication line.

According to still further aspect of the present invention, there is provided a portable memory medium, wherein a program is stored for executing, in response to loading in a client personal computer, a process of checking whether use by a particular user is allowed, a process of monitoring the state of host personal computer connected via a communication line, a process of turning on the power supply of the host personal computer when in the “off” state, and a process of prescribing start and control operations executed after the power supply has been turned on.

The portable memory medium is a USB memory, a MO disc, a flash memory, a memory card or a floppy disc.

According to other aspect of the present invention, there is provided a personal computer control system using portable telephone set, wherein the portable telephone set is loaded with a portable memory medium in which control program of a personal computer operation is stored and a personal computer are connected via a USB cable to the portable telephone set, and the personal computer operation is controlled on the basis of programs stored in the portable memory medium.

A predetermined application program for the personal computer is stored in the portable memory medium. The predetermined application programs are prepared in a server connected via the internet to the personal computer. The access to the portable memory medium during use of the personal computer is prohibited. At the time of ending the use of the personal computer the operation data are stored only in the portable memory medium.

According to still other aspect of the present invention, there is provided a personal computer control system using portable telephone set, wherein a portable telephone set, in which a portable memory medium with personal computer operation control programs stored therein, and a personal computer are connected via a USB cable to each other, the personal computer operation is controlled on the basis of programs stored in the portable memory medium, and a host personal computer connected via a communication line to the personal computer is started and controlled.

In response to the loading of the portable memory medium in the portable telephone set, a predetermined program of the personal computer is started, the state of the host personal computer is monitored, and the power supply thereof is turned on when in the “off” state, thereby starting and controlling the host personal computer. The data exchanged between the personal computer and the host personal computer is enciphered. The data sent out from the client personal computer is instruction data inputted from an input means, and the data sent out from the host personal computer is differential data with respect to the immediately preceding sent-out data. At the end of use of the host personal computer, the final process data is stored in the portable memory medium or in the host personal computer. The portable memory medium is an SD card, a memory stick flash memory or a USB memory. The portable memory medium has a common format data arrangement for permitting signal processes in both the portable telephone set and the personal computer.

According to further aspect of the present invention, there is provided a portable telephone set comprising a loading part, in which a portable memory medium with personal computer operation control programs stored therein is loaded, and a USB cable connection port for connection to the personal computer, the program being started in response to the loading of the portable memory medium.

In the portable memory medium are stored predetermined application programs for the personal computer. At the end of the personal computer control, the operation data are stored in the sole portable memory medium. In response to the loading of the portable memory medium in the portable telephone set, the state of the host personal computer connected via a communication line to the personal computer is monitored under control of the personal computer, and the host personal computer is started and controlled after turning on its power supply when in the “off” state. The portable memory medium is an SD card, a memory stick flash memory or a USB memory.

Other objects and features will be clarified from the following description with reference to attached drawings.

### BRIEF DESCRIPTION OF THE DRAWINGS

FIG. 1 is a view showing an arrangement example of the personal computer control system using personal memory medium according to an embodiment of the present invention;

FIG. 2 is a view for describing the concept underlying the embodiment of the present invention;

FIG. 3 is a view showing an example of the personal computer display subsequent to the start of operation in the embodiment of the present invention;

FIG. 4 is a view of the route of the menu bar shown in FIG. 3;

FIG. 5 is a flow chart showing a more specific routine of operation in the embodiment of the present invention;

FIG. 6 is a flow chart showing a routine from the USB memory connection till the personal computer control in the embodiment of the present invention;

FIG. 7 is a flow chart showing a routine including an ending process in the case of removing the USB memory during operation;

FIG. 8 is a view showing the system arrangement of the personal computer control system with portable memory medium according to an embodiment of the present invention;

FIG. 9 shows examples of work area applications displayed on the display in the embodiment of the present invention;

FIG. 10 is a flow chart for describing the operation routine in the embodiment of the present invention;

FIG. 11 is a view showing an arrangement example of the personal computer control system using portable telephone set according to the embodiment of the present invention;

FIG. 12 is a flow chart showing an operation routine in the embodiment;

FIG. 13 is a view showing an essential internal arrangement of the portable telephone set in the embodiment; and

FIG. 14 is a view showing the system arrangement of the personal computer control system with portable telephone set according to other embodiment of the present invention.

### PREFERRED EMBODIMENTS OF THE PRESENT INVENTION

Preferred embodiments of the present invention will now be described with reference to the drawings.

Now, the arrangement and operation of a preferred embodiment of the personal computer control system using the portable memory medium and the portable memory medium therefor according to the present invention, will be described in detail with reference to the accompanying drawings. While the embodiment will be described in the following in connection with an example of using a USB memory as memory medium, but it is possible as well to any other portable memory medium such as a flash memory, a CD, DVD, MO, a hard disc, a ZIP and a memory card.

According to the present invention, in the portable memory medium is stored software providing a function as so-called middle ware, which is utilized by controlling desired application program among a variety of application program installed in the personal computer used, a start program in the portable memory medium is automatically started when the memory medium is loaded in the personal computer, an authentication process is executed with an authentication process on the portable memory medium or with reference to authentication data such as ID or password inputted by the user, and the desired application program is started.

As the application program, one prepared in the server can be used in case when the personal computer to be used is connected via internet to the server. It is also possible to install in advance the application program in the portable memory medium itself.

When the use of the personal computer is ended with completion of operation, the data used in the operation is stored in the portable memory medium, thus ending the process. At this time, the state data at the end of operation is also stored in the portable memory medium. The state data at the end of operation includes such data as the application program and the data used at the end of operation.

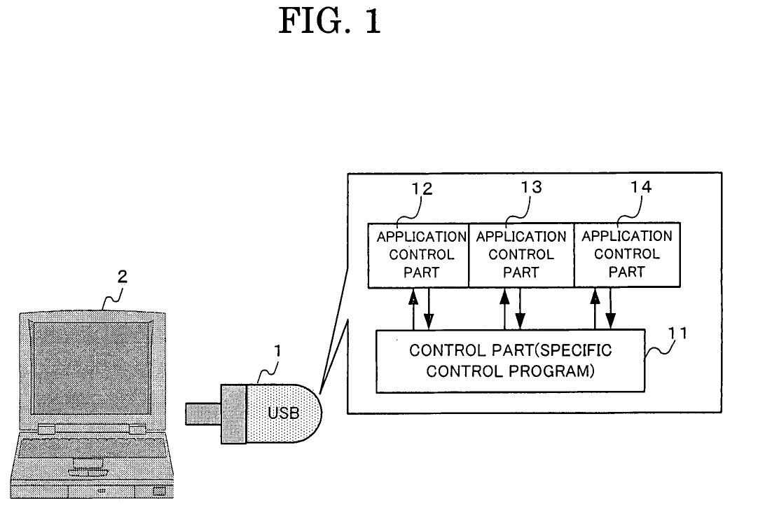

FIG. 1 is a view showing an arrangement example of the personal computer control system using portable memory medium in the embodiment of the present invention. Referring to FIG. 1, when a USB (universal serial bus) memory 1 is inserted or loaded as portable memory medium in or to a USB terminal of a personal computer 2 with a USB interface mounted therein, the operation is started. The drive in which the USB memory 1 is inserted, is set on the personal computer side such that it can be automatically recognized.

The USB memory 1 is very small in size and has large memory capacity compared to other portable memories, as well as having a USB port locking function. Thus, once the USB port is locked by setting a password, the stored data can no longer be read out. Important data and programs thus can be protected. The user thus can easily utilize desired programs, E-mails, etc. by a USB memory, in which data and programs peculiar to the user are stored, and inserting the USB memory in the USB port of any personal computer.

Referring to FIG. 1, the USB memory 1 comprises a control part 11, which executes authentication and exchanges the data with the personal computer 2 and controls application program installed therein, and application control parts 12 to 14, which control a plurality of (i.e., three in this embodiment) application program, respectively.

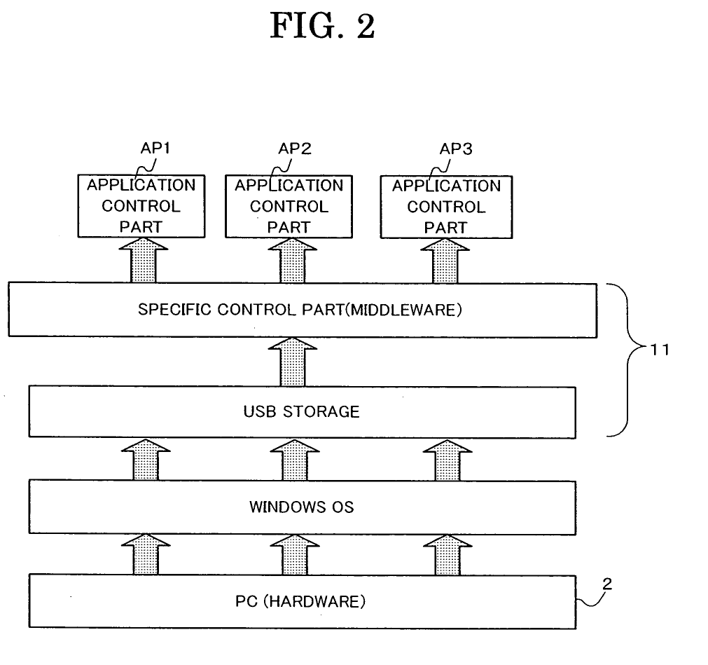

The concept underlying the embodiment of the present invention will now be described with reference to FIG. 2. With insertion of USB memory as portable memory medium, which is capable of being operated on such OS as Windows mounted on the personal computer 2 as hardware, in the USB port of the USB memory, the USB memory 1 as shown in FIG. 1, comprising the control part 11 and application control parts 12 to 14, is operated as middle ware to start and control the operations of the application program AP1 to AP3 installed in the personal computer 2.

The specific control programs installed in the USB memory are a start program, a management task monitoring program and an individual authentication program, and these programs provide functions to be described herein under. The specific control programs adopt such an arrangement that they cannot be copied in any other memory medium for use. The port locking function permits ensuring the security. It is also possible to add and delete application program and customize the application program for each user.

The start program includes such functions as a start function, a password authentication function, a password enciphering function, a time-out function to stop the operation when a predetermined period of time has passed without, any software operation, an installer function to execute program installation, an automatic drive recognition function, a file managing function, a background operating function to execute such processes as changing and processing the background, a display operating function to change the display size, a font adjusting function and an application start restricting function to disable the start of a plurality of installed application program.

The management task monitoring program monitors the operation state of the specific control programs once for every 0.5 sec. and requesting the user to confirm a state change, if any (for instance, a request message is displayed on the display to require a confirmation reply from the user). This program provides an automatic specific control program start function, a state storing function operable with a state storing program to store, in the USB memory, the state prevailed at the time of operation stop so as to permit continual operation in the stored operation state at the next start time, and an automatic application program ending function (such as ending application program by the end of specific control program).

The individual authentication program provides a process function to read out hardware data from the memory medium with the specific control programs stored therein and disable operation with any other medium, this function including such functions as an authentication function when the USB memory is inserted in the user's regular use personal computer.

As shown above, the USB memory according to the present invention is a tool capable of ensuring the user's security and readily carry.

Now, an example of operation using the USB memory in this embodiment will be specifically described.

With the insertion of the USB memory 1 in the personal computer 2, the start program in the USB memory 1 is rendered operative to start the management task monitoring program, thus starting the authentication process. As the authentication process, any method can be used according to the security level, such as fingerprint collation, voiceprint collation and password collation. In the embodiment, a method of collating a password inputted by the user is used. The inputted password has been enciphered.

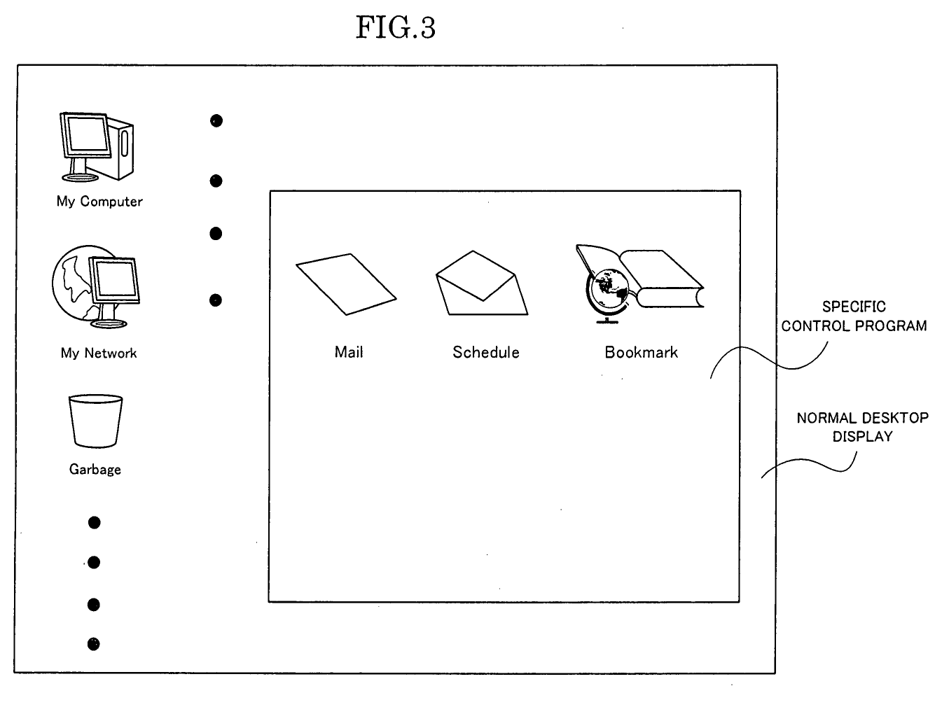

When the user himself or herself is confirmed by such collation process, the next application program drive control on the personal computer side is started. FIG. 3 shows an example of display on the personal computer display when the operation in this embodiment is started. That is, work tables (i.e., areas) are in superimposition displayed on the usual desktop display. In the work table display, icons of applications, such as “My Document”, “Schedule”, “File Management”, “Filer”, “Mail Software”, “Bookmark Management” and “Sound Volume”, these applications being allowed for each user, are displayed, and desired application program can be started by clicking the pertinent icon. In this way, operation is executed on the work table as new operation table, permitting data transfer between the personal computer and the USB memory.

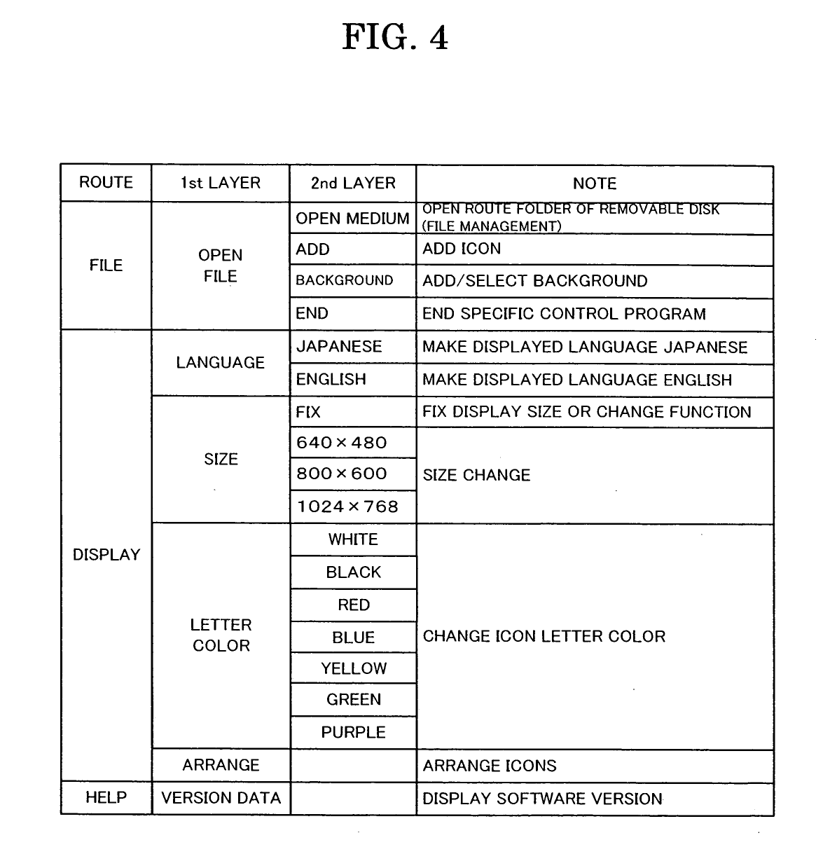

FIG. 4 shows the menu bars shown in FIG. 3, i.e., layers of “File”, “Display” and “Help”. The “File” has one first layer of “Open File”, second layers of “Open media”, i.e., open route holder of the USB memory (i.e., removal disc) (file management), “Add.”, i.e., add icon, “Background”, i.e., select added background, and “End”, i.e., end the pertinent operation. The “Display” has a first layer of “Language” specifying either one of two second layers of “Japanese, and “English”, a first layer of “Size” having two layers of “Setting”, i.e., setting the work area size, and “Changing”, i.e., changing the work area size to “640×480”, “800×600” or “1,024×768”, a first layer of “Letter color”, i.e., change of the icon letter color to two layers of“White”, “Black”, “Red”, “Blue”, “Yellow”, “Green” and “Purple”, a first layer of “Arrange in Row”, i.e., execute icon arrangement in row, and a first row of “Help”, in which version data showing software versions are displayed as one layer.

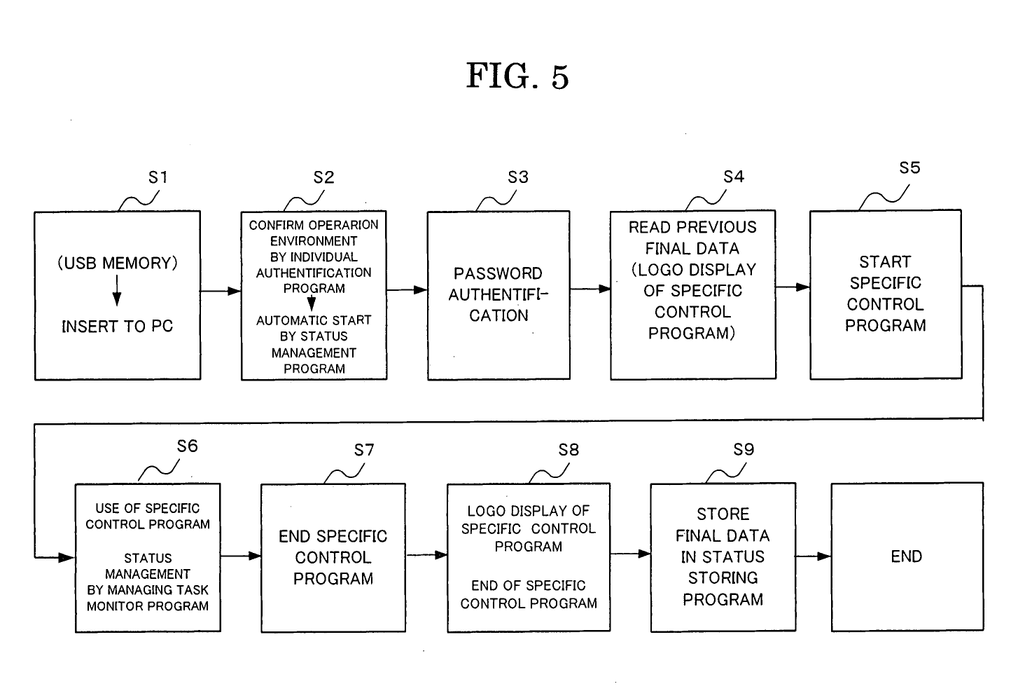

Now, the operation of the embodiment will be described more specifically with reference to the flow chart of FIG. 5.

With insertion of the USB memory in the USB port of the personal computer (step S1), confirmation of the operation environment with the individual authentication program and automatic start with the state management program are executed (step S2), the password inputted by the user is authenticated (step S3), thus making check as to whether the user is the regular user. When it is confirmed that the user is the regular user, the data at the end of the previous (i.e., immediately preceding) operation is read out (step S4) and displayed, and an icon corresponding to a desired application is clicked to cause operation of the application for program start (step S5), thus starting the personal computer operation (step S6). At this time, the state management is executed with the management task monitoring program. At the end of the program operation (step S7), the logotype of the operation is displayed, thus bringing an end to the program operation (step S8). Here, the state data at the end of operation is written in the state storage program in the USB memory (step S9) to bring an end to the final process. The operation state data in the application program at the end of operation is stored in the USB memory. Thus, when the user removes the USB memory, the application program utilized by the user and operation data do not remain in the personal computer at all, and security can be ensured.

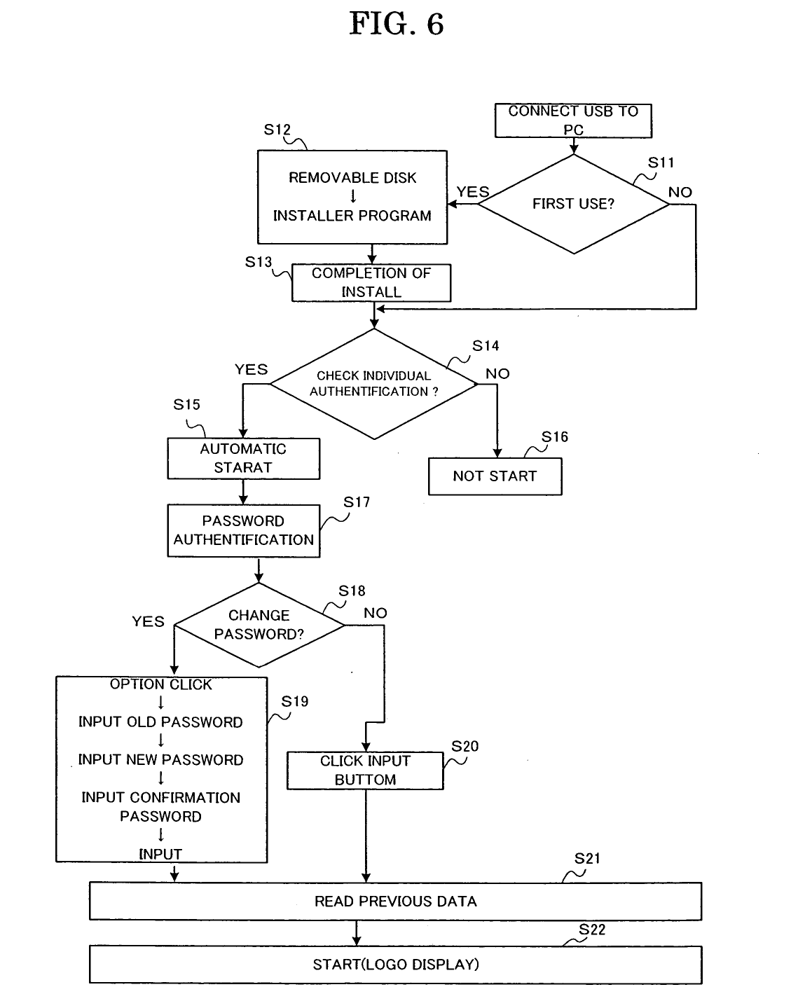

FIG. 6 is a flow chart showing the process routine from the USB memory connection to the personal computer till the personal computer control in the embodiment of the present invention.

With the insertion of the USB memory in (i.e., connection thereto) the personal computer, a check is executed as to whether the USB memory is used by the user for the first time (step S11). In step S12, in the case of the use of the USB memory for the first time, installer program is started to start installing of the program for the specific control program operation. When the installing is completed (step S13), the individual authentication program (i.e., check) is executed (step 14) to check whether the specific control program operation is allows by the individual authentication program. When the operation is allowed (i.e., “YES”), automatic start is executed (step S15). Otherwise (i.e., “NO”), no start is executed (step S16).

When the automatic start is executed in the sep S15, the password authentication is executed (step S17). Then, a check is executed as to whether the password is to be changed (step S18). In the case of the password change, step S9 is executed, in which the option is clicked, and old password, new password and confirmed password are progressively inputted. In the case of no password change, the input button is clicked (step S20).

After the process in the step S19 or S20, the state data (such as “Language”, “Background” and “Letter Color”) at the end of the previous operation is read out (step S21), and the personal computer control according to the present invention is started (step S22).

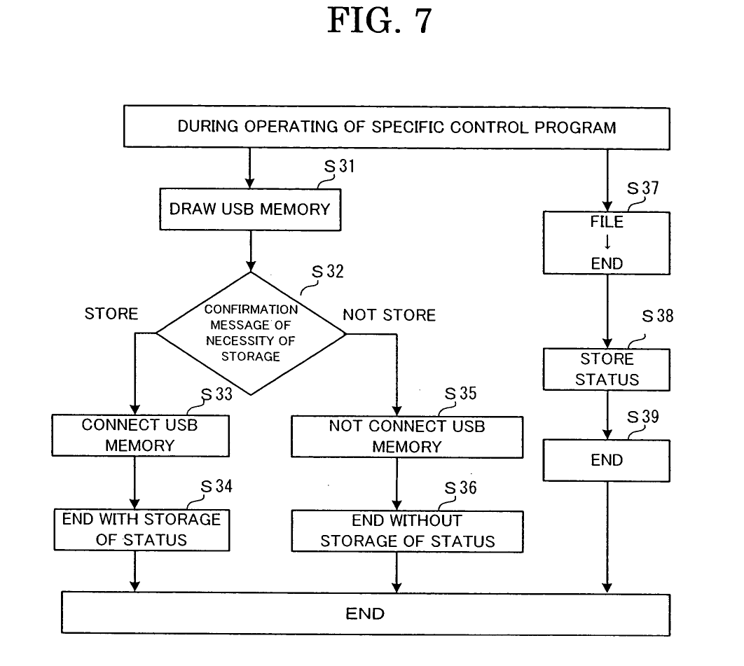

Subsequently, an ending operation including the case of withdrawing the USB memory during operation, will be described as an embodiment of the present invention with reference to the flow chart of FIG. 7. In this case, unlike the normal operation end, a case of erroneous removal of the USB memory by the user can be assumed.

With removal of the USB memory during the personal computer control operation (step S31), a confirmation message as to whether the operation is to be ended after storing the present state data is displayed (step S32). When the storage is desired, the USB memory is loaded (i.e., connected) again (step S33), the state is stored (step S34), and an end is brought to the process. When the storage is not desired (i.e., “NO”) in the step S32, the USB memory is not connected (step S35), and the routine is ended without storing the state (step S36).

When the “File” is ended during the personal computer control operation (step S37), the state is stored in the USB memory (step S38), and an end is brought to the process (step S39).

As has been described, the personal computer control system using the portable memory media according to the present invention, have the following features and convenience advantages. The present invention is a system with a personal computer having a USB port. When the personal computer is connected to a given portable memory medium such as the USB memory, exclusive software is automatically started according to a program stored in the portable memory medium, thus permitting various preset application program functions (such as mail function, schedule function, bookmark function as well as word processor and table forming functions) to be utilized as application program peculiar to the user under ensured security. At the end of use of the personal computer, the operation data inclusive of the operation end state are all stored in the portable memory medium, and no data is stored in the personal computer. No trace of use thus remains. Also, since an enciphered password port lock function is provided for the event of loss of the portable memory medium, further security improvement is possible.

The features and convenience advantages are summarized as follows. (a) It is possible to freely carry mails of the user (private or company). (b) As for the bookmark function, genre-sorted favorite home pages are preliminarily registered, and it is possible to freely enjoy net-surfing in from these home pages. (c) Once a bookmark for company or private purpose has been registered, it is possible to speedily obtain data in any place by connecting the portable memory medium to a personal computer connected to the internet. (d) It is possible to produce documents and edit images in interlock to personal computer. (e) As for the schedule function, it is possible to always carry user's private schedules and company schedules, and schedule management can be executed by connecting such schedules. (f) It is possible to carry data so long as the capacity of the potable memory medium allows. It is thus not necessary to carry a heavy note type personal computer, and the convenience properties can be greatly improved.

With the personal computer control system using the portable memory medium according to the present invention, the following pronounced practical advantages are obtainable. Application program can be used without use of any particular personal computer with ensured security so long as a personal computer is available. Also, in the case of the internet utilization, it is possible to use a personal computer in any place so long as hot services of airports, fast food shops, internet coffee shops, etc. and environments permitting internet utilization are present, and it is thus possible to use the personal computer by setting operation environments peculiar to the user with ensured security.

Now, the arrangement and operation of the personal computer control system using portable memory medium according to another embodiment of the present invention, will be described in detail with reference to the accompanying drawings. In the following description of the embodiment, an example of using USB (universal serial bus) memory will be taken. However, it is also possible to use any other portable memory medium as well, such as MO and floppy disc.

In the USB memory as the personal memory medium stored are programs prescribing routines for controlling the host personal computer connected via the network, such as authentication program and programs for starting, controlling and ending the host personal computer.

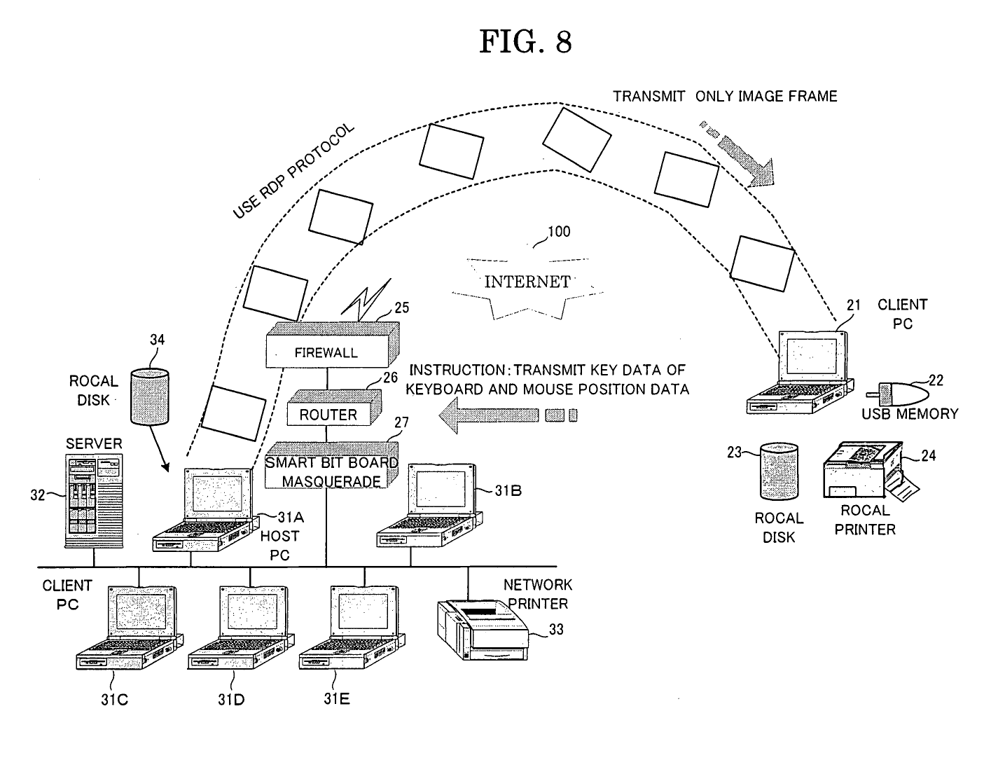

FIG. 8 is a view showing the system arrangement of the personal computer control system with portable memory medium according to the present invention. Data transmission and reception are executed between the client personal computer 21 connected to the communication line, preferably an internet network, and host personal computers 31A to 31E. The client personal computer 21, operable under hot services in airports, fast food shops, internet coffee shops, etc., can start and control either one of the host personal computers 31A to 31E installed in companies (or homes, etc.). The description will now be executed in connection with the case of controlling the host personal computer 31A.

With insertion of the USB memory 22 as portable memory medium in an USB memory port of the client personal computer 21 with USB interface mounted therein, operation is started. The drive in which the USB memory 22 is inserted, is set on the personal computer side such that it can be automatically recognized.

The USB memory 22 is very small in size and has a large memory capacity compared to other portable memory media, and also it has the USB port lock function. Thus, once a password for individual authentication has been set and the USB port has been locked, stored data can no longer be read out, and important data and programs can be safeguarded even in the event of the loss of the USB memory, which is convenient or the application of the present invention. When the user holds the USB memory, in which data and programs peculiar to him or her are stored, and inserts the USB memory in an USB port of a given personal computer connected to the internet network, he or she can utilize desired stored programs, etc.

The individual authentication process in response to the insertion of the USB memory 22 in the USB insertion port in the client personal computer 21, is executed by confirming the identity of a preset ID (number of symbol) peculiar to the user and ID (number of symbol) inputted from an input part (for instance, the keyboard) of the client personal computer 21.

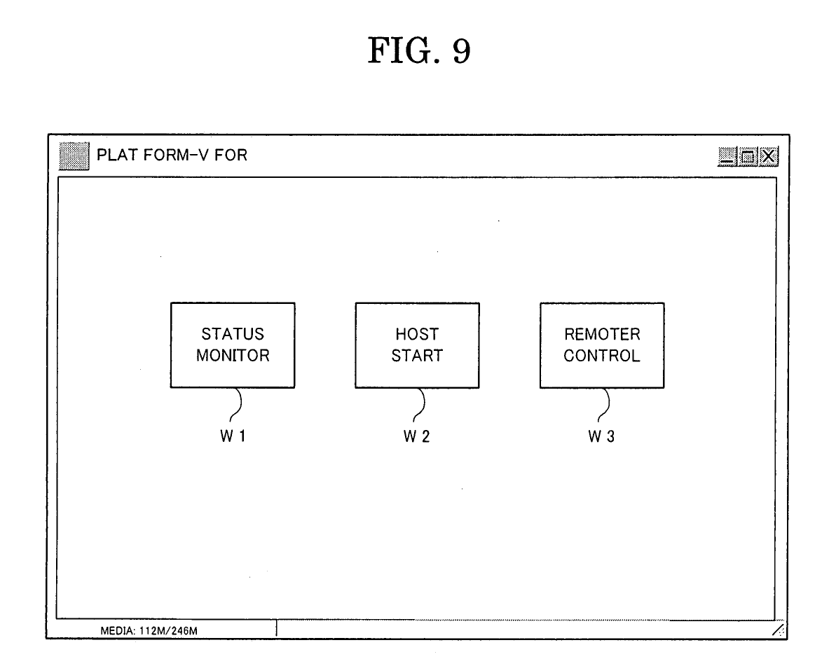

When it is decided that the authentication is “OK”, the work area display is provided on the display part, such as liquid crystal display, of the client personal computer 21. Then, authentication of the password, etc. is executed on the work area display. When it is decided that the authentication is again “OK”, a state management start program is started. At this time, as shown in FIG. 9, a state monitoring icon W1, a host start icon W2 and a remote control icon W3 is provided on the work area display.

The operation based on the state monitoring icon W1 is one for monitoring the state of operation of the host personal computer 31A in the company, own home, etc. When the power supply of the host personal computer 31A is “off”, it is turned on by sending out a signal for turning on the power supply (i.e., Wake-On LAN signal) via the internet network 100 under control based on the host start icon W2. When the power supply to the host personal computer 31A is turned on, log-in in the host personal computer 31A is executed with RDP protocol. After the log-in, an authentication is executed as to whether the user is allowed to use the host personal computer 31A. This authentication, like the user authentication at the start time of the usual personal computer, is executed by checking whether the data inputted from the client personal computer 21 via the internet network 100 is identical with preliminarily registered data. Subsequently, a state is brought about that the operation of the host personal computer 31A is controlled by control based on the remote control icon W3.

Through the above processes, a state is brought about that the client personal computer 21 in a remote place can control either one of the host personal computers 31A to 31E, (i.e., host personal computer 31A in this case).

Referring to FIG. 8 again, when the USB memory 22 has been inserted and all the authentications have been OK, a state is brought about that the operation environments of the host personal computer 31A can be perfectly utilized from the client personal computer 21.

Thus, application program provided in the host personal computer 31A can be utilized from the client personal computer 21, and also such peripheral units as server 32, network printer 33 and local disc 34 connected (i.e., LAN connected) to the host personal computer 31A can be utilized. In this way, an environment is obtained that the client personal computer 21 can utilize the peripheral units connected to the host personal computer 31A and also those connected to itself. For example, it is possible to cause printout of the process results from a printer installed in the company and also from a local printer 24 connected to the client personal computer 21.

While the client personal computer 21 and the host personal computer 31A are connected via the internet network 100 to each other, a fire wall 25 is provided to protect the main personal computer from hacking, viruses, etc. A router 26 and a port masquerade 27 are disposed between the fire wall 25 and the host personal computers 31A to 31E. The router 26 converts global addresses to private addresses. The port masquerade 27 does not only convert an IP address but also discriminates a TCP/UDP port number as the upper protocol of the IP address, thus permitting, for those which utilize different communication ports, a plurality of local nodes with the outside by utilizing one global IP address.

In this embodiment, a plurality of host personal computers 31A to 31E are registered with conversion of one global address to a pluralities of ports and IP addresses by using the port masquerade 27. Because of the provision of the exclusive port masquerade for assigning a plurality of host personal computers with respect to global address “1”, one personal computer can cover a plurality of personal computers, and thus it is possible to cope with one of a plurality of users. In the instant case, one global address is used, and the ports to be used are opened from the fire wall 25.

Through the above operation, the client personal computer 21 can control either one of the host personal computers 31A to 31E via the internet network, and thus can directly utilize the operation environments of an exclusive host personal computer installed in the company or at the own home. Since these operation environments do not only prevail in all the peripheral units connected to the host personal computer as well, but also permit operation of peripheral units, etc. connected to the client personal computer 21, such as the local disc 23 and local printer 24 as shown in FIG. 8. Furthermore, since data exchange is possible as well as common use of clip board, copying and applying are possible. Still further, since sound is in common use, sound output is possible, and a copy guard function is additionally provided in the work area.

Referring to FIG. 8, the client personal computer 21 is connected via the internet network 100 to the host personal computer 31A for communication. The client personal computer 21 basically need only have the communication function, and it does not require installation of any application program or OS therein, so long as it includes a data input part such as a keyboard, a mouse, etc. and a display part for displaying data.

The host personal computer 31A receives data from the client personal computer 21, executes a process corresponding to the received data, sends out the process result data (such as character data and image data) via the internet network 100 to the client personal computer 21 for the display of the data in the client personal computer display part. In this way, the user of the client personal computer 21 executes data exchange with the host personal computer 31A by communication therewith. The communication is executed by using the RDP protocol. The communication with the internet network 100 connecting the client personal computer 21 and the host personal computer 31A is executed by using telephone line, PHS (PIAFS), ADSL, CATV, exclusive line, IOVPN, etc. at a rate corresponding to the characteristic of the selected route.

The user connects the client personal computer 21 via the internet network 100 to the host personal computer 31A, and arranges utilization environments through user confirmation and authentication with ID input and password input. In this state, the user selects environments desired to be utilized with data input from the keyboard. The selectable environments can be set as desired, and include usual internet environments such as home page retrieval and OS, application, etc., desired to be utilized, and desired environments are selected by the user's keyboard operation.

In the above way, the host personal computer 31A is connected via the internet network 100, the selected environments are set, and by the user's use of the data input part such as keyboard, mouse, etc. and the display part on the side of the client personal computer 21, environments can be obtained, in which a personal computer (i.e., host personal computer) mainly utilized in the company, own home, etc. where just like there is a business place usually used by the user can be used without departure from the feel of normal sense.

Specifically, input data by keyboard operation (command data: key data of the keyboard and position data of the mouse) in the client personal computer 21 is sent out via the internet network 100 to the host personal computer 31A and processed in the CPU of the host personal computer 31A and with the selected OS and application program, and data (only the display image) after the process is sent out via the internet network 100 to the user's client personal computer 21 for display on the display part thereof. The user confirming the display inputs data for the next process from the data input part such as keyboard, mouse, etc. This next process data is likewise sent out via the internet network 100 to the host personal computer 31A for processing on the basis of the selected OS and application program and like wise sending to the client personal computer 21. The exchange data between the client personal computer 21 and the host personal computer 31A are enciphered in, for instance, 128 bits to ensure the security.

As described before the client personal computer 21 obviously basically requires only the data input part such as keyboard, mouse, etc. for inputting data, a display part for displaying data and a communication function permitting access to the internet network. The rate of the CPU, the memory capacity of the memory medium and the kinds or versions of the OS give rise to no trouble, and the required functions can be fulfilled even with a mobile portable terminal (such as PDA) or a portable telephone set.

Particularly, in mobile environments at a low communication rate compared to the communication rate (of several MHz to several ten MHz) in fixed environments such as ADSL, CATV, optical cable, etc., the usual large capacity data communication is heavy, and high rate communication is difficult. According to the present invention, no such problem arises even in such a case. The conventional communication via the internet network, is executed as mutual communication through the host personal computer side process and the client personal computer side process, and the data transfer rate may be reduced due to communication environments in packet communication. Therefore, even when the host personal computer side CPU operation is executed at a super-high rate, an overall high rate processing characteristics can not be obtained unless client personal computer side process, the CPU operation and write/read of data in internal memory are at high rates.

In this embodiment, on the side of the client personal computer 21 only the keyboard data input function and the data display-function are executed, and basically unlike the usual personal computer process, and data process in the CPU and process of writing and reading data in and from memory are not executed. Thus, no operation rate restriction due to these processes is present. Thus, in the system according to the present invention, basically the host personal computer side process rate is the operation rate, and high rate operation characteristics compared to the prior art are maintained.

In this embodiment, instruction data are sent out from the client personal computer 21, while the quantity of data transmitted from the side of the host personal computer 31A is greatly reduced compared to the prior art with the adoption of the so-called differential data transmission system, in which only data having a difference in comparison to the immediately preceding data is sent out. This is particularly pronounced in the case of the image data transfer. While the image data quantity is usually large, the image change part in the frame cycle is not so large. Thus, with such an arrangement as to send out only the change part image data, small capacity data transmission and high rate data transmission are possible, and no stress is given to the user.

As shown above, in this embodiment the virtual performance is obtained, and only the instruction data from the client personal computer 21 and the result data from the host personal computer 31A bilaterally travel via the internet network 100. Thus, the communication data quantity is small, and even narrow band communication is not felt as heavy communication. Also, in the broad band communication, even just like from an external personal computer the sense speed of the host personal computer itself is obtainable.

In this embodiment, the data sent out from the client personal computer 21 and the data sent out from the side of the host personal computer 31A are enciphered at, for instance, 128 bits, and very high security inclusive of the above plurality of authentication processes is ensured. Thus, by providing a restriction that the data obtained by using the host personal computer 31A is stored in the internal memory in the host personal computer 31A or in the USB memory 22 itself, it is possible to obtain uni-dimensional management of data and evade confusion due to scattering of the existing data.

In the embodiment, when a host personal computer in the company or at the own home is in use, it is controlled such that the display on its display part is locked so that data concerning the operation contents are not displayed (for instance, the display is held “off” or fixed). When the use of the host personal computer with the client personal computer 21 is ended, a control signal for ending the operation of the host personal computer 31A and turning off the power supply is sent out. It is also possible to turn off the operation and power supply of peripheral unit (such as a printer) connected to the host personal computer.

As has been shown, according to the present invention it is possible to use the host personal computer in the same environments at any time and in any pace so long as the host personal computer is connected via the communication line such as an internet network. The host personal computer need not have its power supply always “on”, and only when required, the power supply can be turned on from the external client personal computer for using the host personal computer, and also the peripheral units such as a printer connected to the host personal computer can be used likewise by turning on the power supply. It is thus possible to save power and reinforce the security.

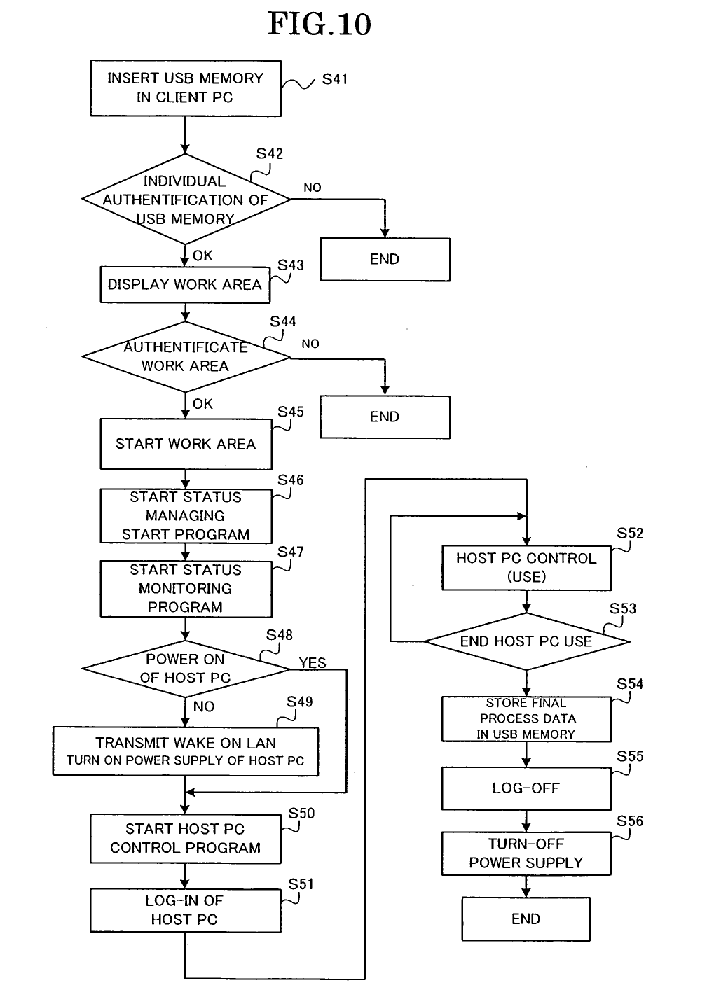

FIG. 10 is a flow chart for describing the operation routine in the embodiment of the present invention.

First, by inserting the USB memory 22 in the insertion port of the client personal computer 21 (step S41), the individual authentication process for the USB memory 22 is executed (step S42). When this authentication is “NO”, it is not decided that the user is allowed to use the USB memory, and an end is brought to the routine. When it is confirmed that the authentication is “OK”, the work area display is provided on the display part of the client personal computer 21 (step S43), and an authentication process concerning the password or the like is executed (step S44).

When the password authentication in the step S44 is “NO”, an end is brought to the routine. When the authentication is “YES”, an end is brought to the routine. When the authentication is “OK”, the work area is started (step S45), and the state management raising program is started from the work area (step S46). Then, the state monitoring program is started (step S47), and the operation state (i.e., whether the power supply is “on” or “off”) of the host personal computer 31A installed in the company, the own home, etc. is monitored (step S48).

When it is found in the step S48 that the power supply of the host personal computer 31A is “off”, a Wake-On LAN signal is sent out via the internet network 100 to turn on the power supply of the host personal computer 31A (step S49). When the host personal computer power supply is “on”, the host personal computer control program is started (step S50), and log-in in the host personal computer 31A is executed with the RDP protocol (step S51).

Subsequent to the log-in in the step S51, the use and control of the host personal computer 31A with the remote control program is executed (step S52). The end of use of the host personal computer 31A is checked (step S53). When the use is not ended, the use of the host personal computer is continued. When the use has been ended, the shut-down program is started, and the final process data is stored in the USB memory (step S54). Also, the log-off of the host personal computer is executed (step S55), and the power supply is turned off (step S56), thus bringing an end to the operation.

With the personal computer control system using personal memory medium according to the above embodiment, the following pronounced practical advantages are obtainable.

Specifically, a host personal computer connected to a communication line such as an internet network is controlled by loading (i.e., inserting) a portable memory medium such as a USB memory in a client personal computer connected to the communication line in, and the host computer utilization environments can be directly utilized at any time and in any place. Even if the power supply of the post personal computer is turned off, it is turned on and is operable by the client personal computer.

Further remarkable advantages in ensuring security are obtainable owing to the fact that the data exchanged between the client and host personal computers have been enciphered, and a plurality of authentication stages such as authentication by the personal memory medium itself, authentication on the work area at the time of loading of the portable memory medium on the client personal computer and authentication at the time of accessing the host personal computer.

Furthermore, essentially the client personal computer has to have only the communication function, the input function and the display function, that is, it is unnecessary to store OS or any application program, thus permitting simplification of the system.

Still further, when the utilization of the host personal computer has been ended, the final data is stored in the portable memory medium loaded in the client personal computer, that is, no trace of utilization data remains in the client personal computer, and security is ensured in this respect. Further improvement in the security aspect is possible in the event of loss of the portable memory medium, because of the provision of the password port lock function.

Moreover, the data sent out from the client personal computer is instruction data from the keyboard, mouse, etc., and data sent out from the host personal computer is the difference data with respect to the immediately preceding sent-out data. Thus, even when the transmitted data is image data, the transfer capacity may be small, and high rate data transmission is possible.

Now, the arrangement and operation of the personal computer control system using portable memory medium according to other embodiment of the present invention, will be described in detail with reference to the accompanying drawings. In the following description of the embodiment, an example of using USB (universal serial bus) memory will be taken. However, it is also possible to use any other portable memory medium as well, such as MO and floppy disc.

In the USB memory as the personal memory medium are stored programs prescribing routines for controlling the host personal computer connected via the network, such as authentication program and programs for starting, controlling and ending the host personal computer.

FIG. 8 is a view showing the system arrangement of the personal computer control system with portable memory medium according to the present invention. Data transmission and reception are executed between the client personal computer 21 connected to the communication line, preferably an internet network, and host personal computers 31A to 31E. The client personal computer 21, operable under hot services in airports, fast food shops, internet coffee shops, etc., can start and control either one of the host personal computers 31A to 31E installed in companies (or homes, etc.). The description will now be executed in connection with the case of controlling the host personal computer 31A.

With insertion of the USB memory 22 as portable memory medium in an USB memory port of the client personal computer 21 with USB interface mounted therein, operation is started. The drive in which the USB memory 22 is inserted, is set on the personal computer side such that it can be automatically recognized.

The USB memory 22 is very small in size and has a large memory capacity compared to other portable memory media, and also it has a USB port lock function. Thus, once a password for individual authentication has been set and the USB port has been locked, stored data can no longer be read out, and important data and programs can be safeguarded even in the event of the loss of the USB memory, which is convenient or the application of the present invention. When the user holds the USB memory, in which data and programs peculiar to him or her are stored, and inserts the USB memory in an USB port of a given personal computer connected to the internet network, he or she can utilize desired stored programs, etc.

The individual authentication process in response to the insertion of the USB memory 22 in the USB insertion port in the client personal computer 21, is executed by confirming the identity of a preset ID (number of symbol) peculiar to the user and ID (number of symbol) inputted from an input part (for instance, the keyboard) of the client personal computer 21.

When it is decided that the authentication is “OK”, the work area display is provided on the display part, such as liquid crystal display, of the client personal computer 21. Then, authentication of the password, etc. is executed on the work area display. When it is decided that the authentication is again “OK”, a state management start program is started. At this time, as shown in FIG. 9, a state monitoring icon W1, a host start icon W2 and a remote control icon W3 is provided on the work area display.

The operation based on the state monitoring icon W1 is one for monitoring the state of operation of the host personal computer 31A in the company, own home, etc. When the power supply of the host personal computer 31A is “off”, it is turned on by sending out a signal for turning on the power supply (i.e., Wake-On LAN signal) via the internet network 100 under control based on the host start icon W2. When the power supply to the host personal computer 31A is turned on, log-in in the host personal computer 31A is executed with RDP protocol. After the log-in, an authentication is executed as to whether the user is allowed to use the host personal computer 31A. This authentication, like the user authentication at the start time of the usual personal computer, is executed by checking whether the data inputted from the client personal computer 21 via the internet network 100 is identical with preliminarily registered data. Subsequently, a state is brought about that the operation of the host personal computer 31A is controlled by control based on the remote control icon W3.

Through the above processes, a state is brought about that the client personal computer 21 in a remote place can control either one of the host personal computers 31A to 31E, i.e., host personal computer 31A in this case).

Referring to FIG. 8 again, when the USB memory 22 has been inserted and all the authentications have been OK, a state is brought about that the operation environments of the host personal computer 31A can be perfectly utilized from the client personal computer 21.

Thus, application program provided in the host personal computer 31A can be utilized from the client personal computer 21, and also such peripheral units as server 32, network printer 33 and local disc 34 connected (i.e., LAN connected) to the host personal computer 31A can be utilized. In this way, an environment is obtained that the client personal computer 21 can utilize the peripheral units connected to the host personal computer 31A and also those connected to itself. For example, it is possible to cause printout of the process results from a printer installed in the company and also from a local printer 24 connected to the client personal computer 21.

While the client personal computer 21 and the host personal computer 31A are connected via the internet network 100 to each other, a fire wall 25 is provided to protect the main personal computer from hacking, viruses, etc. A router 26 and a port masquerade 27 are disposed between the fire wall 25 and the host personal computers 31A to 31E. The router 26 converts global addresses to private addresses. The port masquerade 27 does not only convert an IP address but also discriminates a TCP/UDP port number as the upper protocol of the IP address, thus permitting, for those which utilize different communication ports, a plurality of local nodes with the outside by utilizing one global IP address.

In this embodiment, a plurality of host personal computers 31A to 31E are registered with conversion of one global address to a pluralities of ports and IP addresses by using the port masquerade 27. Because of the provision of the exclusive port masquerade for assigning a plurality of host personal computers with respect to global address “1”, one personal computer can cover a plurality of personal computers, and thus it is possible to cope with one of a plurality of users. In the instant case, one global address is used, and the ports to be used are opened from the fire wall 25.

Through the above operation, the client personal computer 21 can control either one of the host personal computers 31A to 31E via the internet network, and thus can directly utilize the operation environments of an exclusive host personal computer installed in the company or at the own home. Since these operation environments do not only prevail in all the peripheral units connected to the host personal computer as well, but also permit operation of peripheral units, etc. connected to the client personal computer 21, such as the local disc 23 and local printer 24 as shown in FIG. 8. Furthermore, since data exchange is possible as well as common use of clip board, copying and applying are possible. Still further, since sound is in common use, sound output is possible, and a copy guard function is additionally provided in the work area.

Referring to FIG. 8, the client personal computer 21 is connected via the internet network 100 to the host personal computer 31A for communication. The client personal computer 21 basically need only have the communication function, and it does not require installation of any application program or OS therein, so long as it includes a data input part such as a keyboard, a mouse, etc. and a display part for displaying data.

The host personal computer 31A receives data from the client personal computer 21, executes a process corresponding to the received data, sends out the process result data (such as character data and image data) via the internet network 100 to the client personal computer 21 for the display of the data in the client personal computer display part. In this way, the user of the client personal computer 21 executes data exchange with the host personal computer 31A by communication therewith. The communication is executed by using the RDP protocol. The communication with the internet network 100 connecting the client personal computer 21 and the host personal computer 31A is executed by using telephone line, PHS (PIAFS), ADSL, CATV, exclusive line, IOVPN, etc. at a rate corresponding to the characteristic of the selected route.

The user connects the client personal computer 21 via the internet network 100 to the host personal computer 31A, and arranges utilization environments through user confirmation and authentication with ID input and password input. In this state, the user selects environments desired to be utilized with data input from the keyboard. The selectable environments can be set as desired, and include usual internet environments such as home page retrieval and OS, application, etc., desired to be utilized, and desired environments are selected by the user's keyboard operation.

In the above way, the host personal computer 31A Is connected via the internet network 100, the selected environments are set, and by the user's use of the data input part such as keyboard, mouse, etc. and the display part on the side of the client personal computer 21, environments can be obtained, in which a personal computer (i.e., host personal computer) mainly utilized in the company, own home, etc. where just like there is a business place usually used by the user can be used without departure from the feel of normal sense.

Specifically, input data-by keyboard operation (command data: key data of the keyboard and position data of the mouse) in the client personal computer 21 is sent out via the internet network 100 to the host personal computer 21A and processed in the CPU of the host personal computer 21A and with the selected OS and application program, and data (only the display image) after the process is sent out via the internet network 100 to the user's client personal computer 21 for display on the display part thereof. The user confirming the display inputs data for the next process from the data input part such as keyboard, mouse, etc. This next process data is likewise sent out via the internet network 100 to the host personal computer 31A for processing on the basis of the selected OS and application program and likewise sending to the client personal computer 21. The exchange data between the client personal computer 21 and the host personal computer 31A are enciphered in, for instance, 128 bits to ensure the security.

As described above the client personal computer 21 obviously basically requires only the data input part such as keyboard, mouse, etc. for inputting data, a display part for displaying data and a communication function permitting access to the internet network. The rate of the CPU, the memory capacity of the memory medium and the kinds or versions of the OS give rise to no trouble, and the required functions can be fulfilled even with a mobile portable terminal (such as PDA) or a portable telephone set.

Particularly, in mobile environments at a low communication rate compared to the communication rate (of several MHz to several ten MHz) in fixed environments such as ADSL, CATV, optical cable, etc., the usual large capacity data communication is heavy, and high rate communication is difficult. According to the present invention, no such problem arises even in such a case. The conventional communication via the internet network, is executed as mutual communication through the host personal computer side process and the client personal computer side process, and the data transfer rate may be reduced due to communication environments in packet communication. Therefore, even when the host personal computer side CPU operation is executed at a super-high rate, an overall high rate processing characteristics can not be obtained unless client personal computer side process, the CPU operation and write/read of data in internal memory are at high rates.

In this embodiment, on the side of the client personal computer 21 only the keyboard data input function and the data display function are executed, and basically unlike the usual personal computer process, and data process in the CPU and process of writing and reading data in and from memory are not executed. Thus, no operation rate restriction due to these processes is present. Thus, in the system according to the present invention, basically the host personal computer side process rate is the operation rate, and high rate operation characteristics compared to the prior art are maintained.

In this embodiment, instruction data are sent out from the client personal computer 21, while the quantity of data transmitted from the side of the host personal computer 31A is greatly reduced compared to the prior art with the adoption of the so-called differential data transmission system, in which only data having a difference in comparison to the immediately preceding data is sent out. This is particularly pronounced in the case of the image data transfer. While the image data quantity is usually large, the image change part in the frame cycle is not so large. Thus, with such an arrangement as to send out only the change part image data, small capacity data transmission and high rate data transmission are possible, and no stress is given to the user.

As shown above, in this embodiment the virtual performance is obtained, and only the instruction data from the client personal computer 21 and the result data from the host personal computer 31A bilaterally travel via the internet network 100. Thus, the communication data quantity is small, and even narrow band communication is not felt as heavy communication. Also, in the broad band communication, even just like from an external personal computer the sense speed of the host personal computer itself is obtainable.

In this embodiment, the data sent out from the client personal computer 21 and the data sent out from the side of the host personal computer 31A are enciphered at, for instance, 128 bits, and very high security inclusive of the above plurality of authentication processes is ensured.

Thus, by providing a restriction that the data obtained by using the host personal computer 31A is stored in the internal memory in the host personal computer 31A or in the USB memory 22 itself, it is possible to obtain uni-dimensional management of data and evade confusion due to scattering of the existing data.

In the embodiment, when a host personal computer in the company or at the own home is in use, it is controlled such that the display on its display part is locked so that data concerning the operation contents are not displayed (for instance, the display is held “off” or fixed).

When the use of the host personal computer with the client personal computer 21 is ended, a control signal for ending the operation of the host personal computer 31A and turning off the power supply is sent out. It is also possible to turn off the operation and power supply of peripheral unit (such as a printer) connected to the host personal computer.

As has been shown, according to the present invention it is possible to use the host personal computer in the same environments at any time and in any pace so long as the host personal computer is connected via the communication line such as an internet network. The host personal computer need not have its power supply always “on”, and only when required, the power supply can be turned on from the external client personal computer for using the host personal computer, and also the peripheral units such as a printer connected to the host personal computer can be used likewise by turning on the power supply. It is thus possible to save power and reinforce the security.

FIG. 10 is a flow chart for describing the operation routine in the embodiment of the present invention.

First, by inserting the USB memory 22 in the insertion port of the client personal computer 21 (step S41), the individual authentication process for the USB memory 22 is executed (step S42). When this authentication is “NO”, it is not decided that the user is allowed to use the USB memory, and an end is brought to the routine. When it is confirmed that the authentication is “OK”, the work area display is provided on the display part of the client personal computer 21 (step S43), and an authentication process concerning the password or the like is executed (step S44).

When the password authentication in the step S44 is “NO”, an end is brought to the routine. When the authentication is “YES”, an end is brought to the routine. When the authentication is “OK”, the work area is started (step S45), and the state management raising program is started from the work area (step S46). Then, the state monitoring program is started (step S47), and the operation state (i.e., whether the power supply is “on” or “off”) of the host personal computer 31A installed in the company, the own home, etc. is monitored (step S48).

When it is found in the step S48 that the power supply of the host personal computer 31A is “off”, a Wake-On LAN signal is sent out via the internet network 100 to turn on the power supply of the host personal computer 31A (step S49). When the host personal computer power supply is “on”, the host personal computer control program is started (step S50), and log-in in the host personal computer 31A is executed with the RDP protocol (step S51).

Subsequent to the log-in in the step S51, the use and control of the host personal computer 31A with the remote control program is executed (step S52). The end of use of the host personal computer 31A is checked (step S53). When the use is not ended, the use of the host personal computer is continued. When the use has been ended, the shut-down program is started, and the final process data is stored in the USB memory (step S54). Also, the log-off of the host personal computer is executed (step S55), and the power supply is turned off (step S56), thus bringing an end to the operation.

With the personal computer control system using personal memory medium according to the above embodiment, the following pronounced practical advantages are obtainable.

Specifically, a host personal computer connected to a communication line such as an internet network is controlled by loading (i.e., inserting) a portable memory medium such as a USB memory in a client personal computer connected to the communication line in, and the host computer utilization environments can be directly utilized at any time and in any place.

Even if the power supply of the post personal computer is turned off, it is turned on and is operable by the client personal computer.

Further remarkable advantages in ensuring security are obtainable owing to the fact that the data exchanged between the client and host personal computers have been enciphered, and a plurality of authentication stages are executed such as authentication by the personal memory medium itself, authentication on the work area at the time of loading of the portable memory medium on the client personal computer and authentication at the time of accessing the host personal computer.

Furthermore, essentially the client personal computer has to have only the communication function, the input function and the display function, that is, it is unnecessary to store OS or any application program, thus permitting simplification of the system.

Still further, when the utilization of the host personal computer has been ended, the final data is stored in the portable memory medium loaded in the client personal computer, that is, no trace of utilization data remains in the client personal computer, and security is ensured in this respect. Further improvement in the security aspect is possible in the event of loss of the portable memory medium, because of the provision of the password port lock function.

Moreover, the data sent out from the client personal computer is instruction data from the keyboard, mouse, etc., and data sent out from the host personal computer is the difference data with respect to the immediately preceding sent-out data. Thus, even when the transmitted data is image data, the transfer capacity may be small, and high rate data transmission is possible.

The personal computer control system utilizing the portable telephone set according to other embodiment of the present invention will now be described with reference to the accompanying drawings.

In the embodiment, for realizing the “ubiquitous” environment, desired application programs providing functions as so-called middle ware, are stored in the portable memory medium to be loaded in the portable telephone set. When the portable memory medium is loaded in the portable telephone set and connected via the USB cable to the personal computer, the start program in the portable memory medium is automatically started. If necessary, an authentication process with respect to the memory medium or an authentication process with reference to such authentication data as ID and password inputted by the user, a desired application program is started for the operation. In the following description of the embodiment, a given memory medium is used as a memory medium to be loaded in the portable telephone set. For instance, SD card, memory stick flash memory, USB memory and other different types of memories can be used.

The main concept underlying the present invention is to control a personal computer as the subject of control via a USB cable by the agency of a portable telephone set which is best suited for realizing the “ubiquitous” environment. The portable telephone set is a tool which should always be carried. Thus, with control of the personal computer operation on the basis of a control program stored in the portable memory medium loaded in the portable telephone set, it is possible to obtain internet connection environments with the portable telephone set even when the internet connection environments are absent.

In the portable memory medium, application programs may be stored, or only programs for controlling the personal computer may be stored, while preparing the application programs to be utilized in a server which is connected via the internet.

At the time of ending the use of the personal computer, the processed or operation data is stored in the portable memory medium, thus bringing an end to the process. At this time, the state data at the process end time is stored in the portable memory medium. The state data at the process end time is also stored in the portable memory medium. The state data at the process end time includes application programs and operation data having been in use at the process end time.

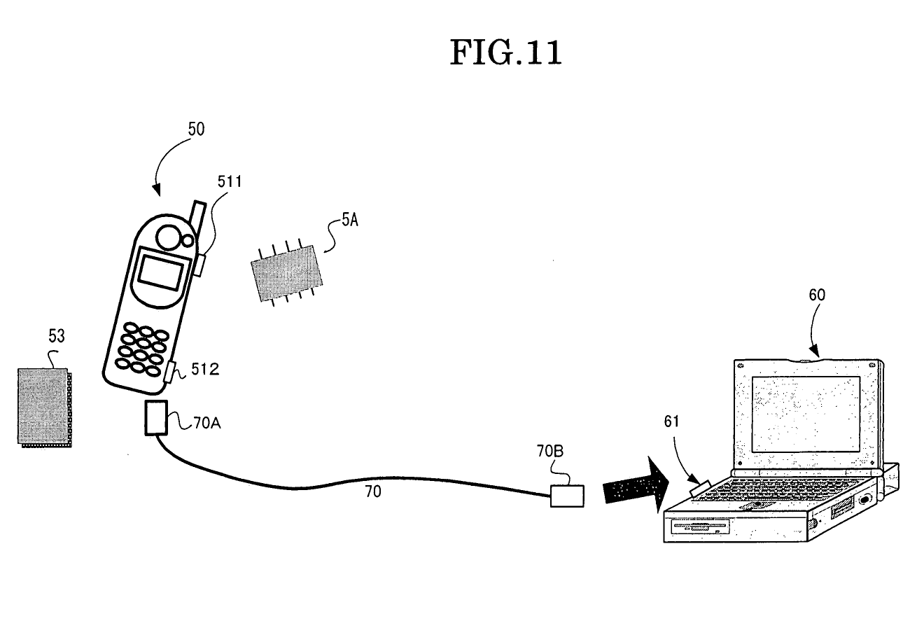

FIG. 11 is a view showing an arrangement example of the personal computer control system using portable telephone set according to the embodiment of the present invention. Referring to FIG. 11, the portable telephone set 50 has a memory medium loading part 501, in which a portable memory medium 5A (such as SD card, memory stick flash memory and USB memory) is loaded as external memory by insertion or like means. In the portable telephone set 50, a battery (i.e., lithium ion battery) 53 is mounted. Furthermore, a USB terminal 70A of a USB cable 70 is connected to the USB port 512 of the portable telephone set 50.

A USB terminal 70B of the USB cable 70 provided at the other end thereof is connected to a personal computer 60, and the personal computer 60 and the portable telephone set 50 are connected via the USB cable 70 to each other.

The portable telephone set 50 is usually used as such, but when it is desired to use personal computer, it is connected to the personal computer 60 via the USB cable 70 as noted above. At this time, the portable memory medium 5A has been loaded in the portable telephone set 50. In this state, the personal computer 60 is controlled on the basis of a program stored in the portable memory medium 5A as will be described later.

For the portable telephone set 50, it is desired that a universal USB cable of USB port MINIB type can be used, that a memory slot for loading the portable memory medium therethrough is provided, that with a POP3/SMTP multi-account specification, mail data can be managed in the portable memory medium, that the battery can be charged from USB and the voice function of the portable telephone set is of a WAV type data specification.

As functions obtainable in this embodiment, functions provided by the portable telephone set 50 itself (for instanc E-mail function and bookmark data input/output. function) are provided, and operations while visually recognizing data shown on a large-size display of the personal computer 60 are possible, thus greatly improving the operation properties. Also, it is possible to utilize E-mail (POP3/SMTP), address diary (for E-mails), telephone diary (for telephone), voice recorder, web contents (such as those favorite), scheduler and camera functions. In these cases, the portable telephone set 50 is connected to the personal computer 60, and the power is supplied from the side of the personal computer 60, so that it is also possible to charge the battery 53.

In the meantime, with the personal computer 60 with the portable telephone set 50, communication environments are provided, and it is possible to obtain communication environments using the personal computer 60 and also internet utilization environments.

Software stored in the personal computer 60 includes mail function (POP3/SMTP), address diary (for E-mails), telephone diary, voice data management, bookmark management (for personal computer and also for portable telephone set), schedule (for personal computer and also for portable telephone set) and bit map arrangement.

The portable memory medium 5A includes a control part for executing the data exchange with the personal computer 60 via the USB cable 70 and also controlling application programs installed in the personal computer 60.

In the portable memory medium 5A are stored desired application programs among the application programs installed in the main personal computer installed by the user in the company or at the own home when the portable memory medium 5A is loaded in the portable telephone set 50 and the portable telephone set 50 and the personal computer 60 are connected via the USB cable 70 to each other, the start program in the portable memory medium 5A is automatically started to cause execution of the authentication process and start of a desired application program, whereby the operation is started.

As for the application program, when the personal computer for use is connected via the internet to the server, it is possible to utilize application programs prepared in the server.

When the use of the personal computer 60 is ended, the data having been used in the operation are stored in the portable memory medium 5A, thus bringing an end to the process. At this time, the state data at the operation end is also stored in the portable memory medium. The state data at the operation end includes such data as application programs and operation data in use at the end time of the operation.

The portable memory medium 5A is arranged to have data configuration of common format to permit signal processes in the portable telephone set 50 and the personal computer 60.

When the portable memory medium 5A, which is operable on windows or like OS installed in the personal computer 60, is loaded in the portable telephone set 50, it is recognized as a removable memory for personal computer control, and the control program in the portable memory medium 5A operates as middle ware. The control program adopts an arrangement that it can not be copied in any other memory medium for utilization. When stopping the personal computer process with the control program, it is possible to store the operation state in the portable memory medium 5A so as to be able to execute continual operation in the stored operation state at the time of the next start.

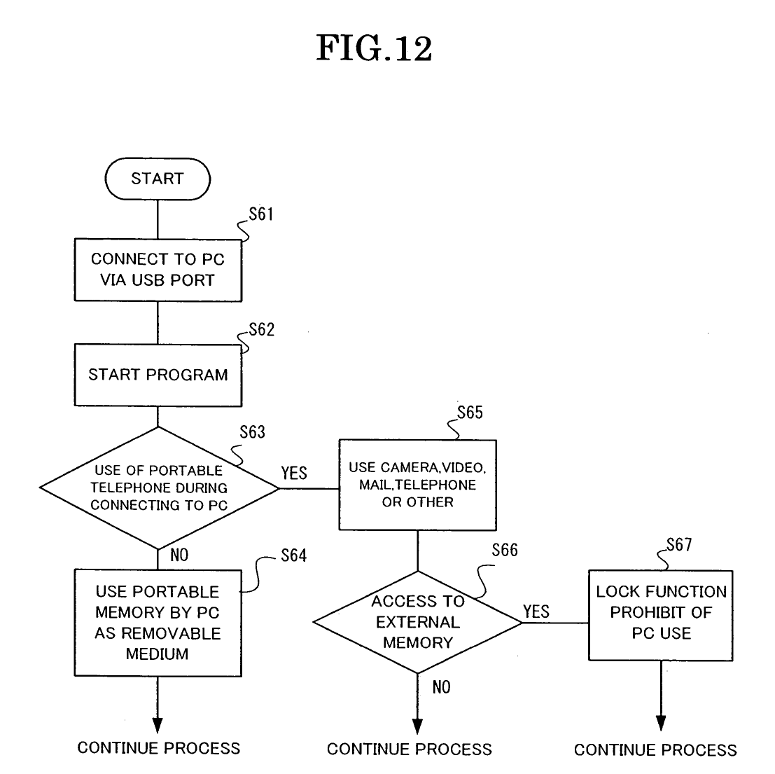

FIG. 12 is a flow chart showing an operation routine in this embodiment.

In this embodiment, in the state that the portable telephone set 50 and the personal computer 60 are connected via the USB cable 70 to each other, that is, during control and use of the personal computer 60, although it is possible to use such portable telephone functions as mail, browser, camera and video, no data input or output with respect to the portable memory medium 5A as expansion memory is possible.

Referring to FIG. 12, when the USB cable 70 is connected to the USB port 512 of the portable telephone set 50 and the USB port 61 of the personal computer 60 (step S61), personal computer control based on an application program stored in the portable memory medium 5A is started (step S62). At this time, it is possible to improve the security by executing an authentication process by a collation method based on the password inputted by the user.

After the process in the step S62, the control operation for the personal computer 60 is started. During the control operation, a check is executed as to whether a portable telephone set function is to be used (step S63), and personal computer control is executed on the basis of the control program stored in the portable memory medium 5A, that is, the portable memory medium 5A in the portable telephone set 50 connected to the personal computer 60 is used as removable memory (step S64). At the time of the end of the routine, the final operation or processed data and state data are stored in the portable memory medium 5A.

When it is decided in the step 63 that a portable telephone set function is to be used during the personal computer operation, it is executed possible to use such portable telephone set functions as camera, video, mail and telephone (step S65), and a check is executed as to whether the portable memory medium 5A as external memory is being accessed (step S66). When the access is not made, the process is continued and when the access is being executed, the personal computer 60 is in use. Thus, the use of the portable memory medium 5A is prohibited, that is, a lock state is brought about (step S67), and the process is continued.

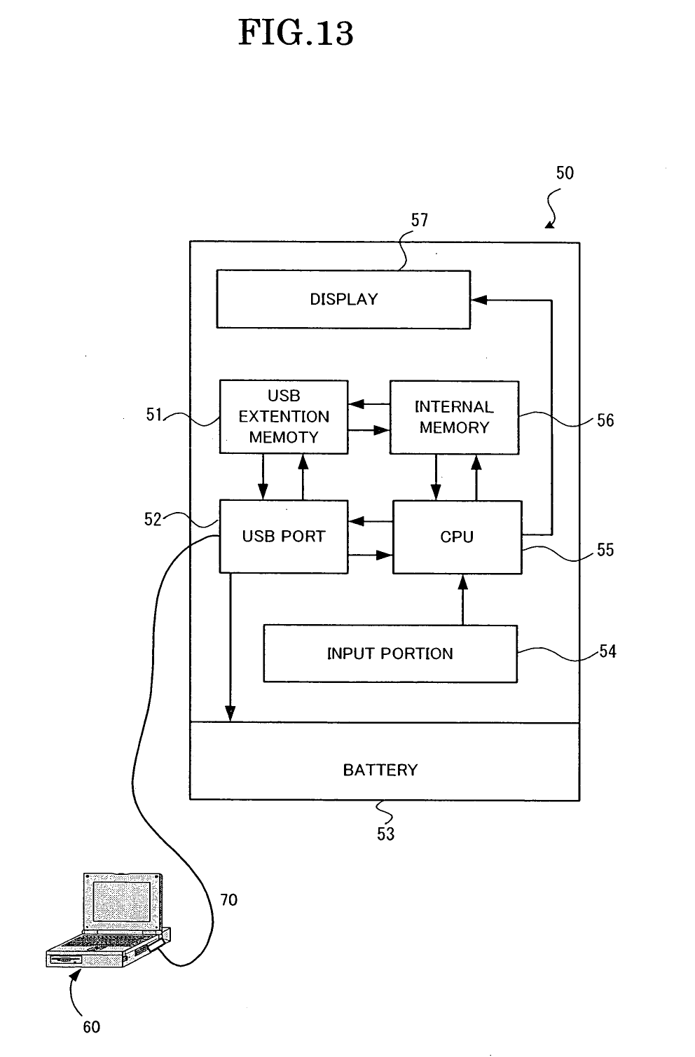

FIG. 13 is a view showing an essential internal arrangement of the portable telephone set 50 in the embodiment. The USB cable 70 is connected between the USB port 512 of the portable telephone set 50 and the USB port 61 of the personal computer 60. In the portable telephone set 50, the portable memory medium 5A as USB expansion memory and the battery 53 are mounted. On the basis of data inputted from an input part 54 such as a key button, a CPU 55 executes process by using an internal memory 56, and process results, operation state, etc. are displayed on a display part 57.

This embodiment is a system with a personal computer having a USB port. When the portable telephone set 50 with a loaded given portable memory medium such as a flash memory is connected via the USB cable 70 to the personal computer 60, exclusive software is automatically started according to a program stored in the portable memory medium, thus permitting use of various preset application program functions (such as mail function, schedule function, bookmark function as well as word processor and table forming functions) as application programs peculiar to the user. At the time of the end of use of the personal computer 60, the operation data inclusive of the operation end state are all stored in the portable memory medium 5A, so that no data, i.e., no trace of use, is stored in the personal computer.

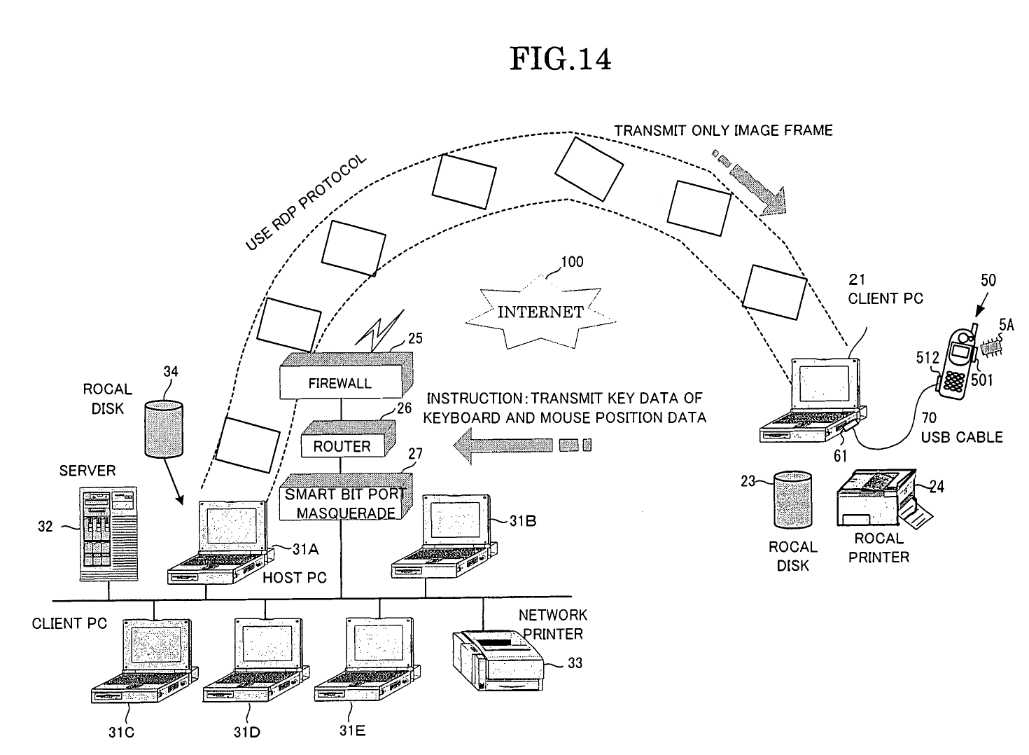

Now, a further embodiment will be described in connection with a case of controlling a main personal computer installed in the company or own home with reference to FIG. 14.

In this embodiment, either one of the host personal computers 31A to 31E is controlled with the portable telephone set 50 and by utilizing a personal computer 21 connected as client to internet network. The embodiment concerns the case of controlling the host personal computer 31A.

With insertion of the portable memory medium 5A in the UDSB port 512 of the portable telephone set 50, the operation is started, and the authentication process is executed. When the authentication is “OK”, the operation state of the host personal computer 31A installed in the company, own home, etc. is monitored according to a program stored in the portable memory medium 5A, and a check is made as to whether the power supply is “on” or “off”. When the power supply of the host personal computer 31A is “off”, it is turned on by sending out a signal (i.e., wake-on LAN signal) for turning on the power supply via an internet network 100, which is set by the portable telephone set 50. The operation of this embodiment is similar to that shown in FIG. 8.

When the power supply of the host personal computer 31A is turned on in this way, log-in in the host personal computer 31A is made with the RDP protocol. After the log-in, authentication as to whether the user is allowed to use the host personal computer 31A is made. This authentication is like the user authentication at the time of the usual personal computer starting, and is made by checking whether data inputted from the client personal computer 21 via the internet network 100 and preliminarily registered data are identical. When the two data are identical, a state for controlling the operation of the host computer 31A is brought about.

Through the above process, a state is brought about that the client personal computer 21 can control either one of the host personal computers 31A to 31E installed in remote places (i.e., host personal computer 31A in this embodiment).

Thus, the application programs installed in the host personal computer 31A can be directly utilized, and also peripheral units connected (i.e., LAN connected) to the host personal computer 31A, such as host personal computer 31A, the server 32, the network printer 33 and the local disc 34, can be utilized.

In this way, an environment is obtained that the client personal computer 21 which is connected via the USB cable 70 to the portable telephone set 50 with the portable memory medium 5A loaded therein, can utilize the peripheral units connected to the host personal computer 31A and also those connected thereto. For example, it is possible to cause printout of the process results from a printer installed in the company and also from a local printer 24 connected to the client personal computer 21.

While the client personal computer 21 and the host personal computer 31A are connected via the internet network 100 to each other, a fire wall 25 is provided to protect the main personal computer from hacking, viruses, etc. A router 26 and a port masquerade 27 are disposed between the fire wall 25 and the host personal computers 31A to 31E. The router 26 converts global addresses to private addresses. The port masquerade 27 does not only convert an IP address but also discriminates a TCP/UDP port number as the upper protocol of the IP address, thus permitting, for those which utilize different communication ports, a plurality of local nodes with the outside by utilizing one global IP address.

In this embodiment, a plurality of host personal computers 31A to 31E are registered with conversion of one global address to a pluralities of ports and IP addresses by using the port masquerade 27. Because of the provision of the exclusive port masquerade for assigning a plurality of host personal computers with respect to global address “1”, one personal computer can cover a plurality of personal computers, and thus it is possible to cope with one of a plurality of users. In the instant case, one global address is used, and the ports to be used are opened from the fire wall 25.

Through the above operation, the client personal computer 21 can control either one of the host personal computers 31A to 32E via the internet network, and thus can directly utilize the operation environments of an exclusive host personal computer installed in the company or at the own home. Since these operation environments do not only prevail in all the peripheral units connected to the host personal computer as well, but also permit operation of peripheral units, etc. connected to the client personal computer 21, such as the local disc 23 and local printer 24 as shown in FIG. 14. Furthermore, since data exchange is possible as well as common use of clip board, copying and applying are possible. Still further, since sound is in common use, sound output is possible, and a copy guard function is additionally provided in the work area.

Referring to FIG. 14, the client personal computer 21 is connected via the internet network 100 to the host personal computer 31A for communication. The client personal computer 21 basically need only have the communication function, and it does not require installation of any application program or OS therein, so long as it includes a data input part such as a keyboard, a mouse, etc. and a display part for displaying data.

The host personal computer 31A receives data from the client personal computer 21, executes a process corresponding to the received data, sends out the process result data (such as character data and image data) via the internet network 100 to the client personal computer 21 for the display of the data in the client personal computer display part. In this way, the user of the client personal computer 21 executes data exchange with the host personal computer 31A by communication therewith. The communication is executed by using the RDP protocol. The communication with the internet network 100 connecting the client personal computer 21 and the host personal computer 31A is executed by using telephone line, PHS (PIAFS), ADSL, CATV, exclusive line, IOVPN, etc. at a rate corresponding to the characteristic of the selected route.

The user connects the client personal computer 21 via the internet network 100 to the host personal computer 31A, and arranges utilization environments through user confirmation and authentication with ID input and password input. In this state, the user selects environments desired to be utilized with data input from the keyboard. The selectable environments can be set as desired, and include usual internet environments such as home page retrieval and OS, application, etc., desired to be utilized, and desired environments are selected by the user's keyboard operation.

In the above way, the host personal computer 31A is connected via the internet network 100, the selected environments are set, and by the user's use of the data input part such as keyboard, mouse, etc. and the display part on the side of the client personal computer 21, environments can be obtained, in which a personal computer (i.e., host personal computer) mainly utilized in the company, own home, etc. where just like there is a business place usually used by the user can be used without departure from the feel of normal sense.

In the embodiment, input data by keyboard operation (command data: key data of the keyboard and position data of the mouse) in the client personal computer 21 is sent out via the internet network 100 to the host personal computer 21A and processed in the CPU of the host personal computer 31A and with the selected OS and application program, and data (only the display image) after the process is sent out via the internet network 100 to the user's client personal computer 21 for display on the display part thereof. The user confirming the display inputs data for the next process from the data input part such as keyboard, mouse, etc. This next process data is likewise sent out via the internet network 100 to the host personal computer 31A for processing on the basis of the selected OS and application program and likewise sending to the client personal computer 31. The exchange data between the client personal computer 21 and the host personal computer 31A are enciphered in, for instance, 128 bits to ensure the security.

As described before the client personal computer 21 obviously basically requires only the data input part such as keyboard, mouse, etc. for inputting data, a display part for displaying data and a communication function permitting access to the internet network. The rate of the CPU, the memory capacity of the memory medium and the kinds or versions of the OS give rise to no trouble, and the required functions can be fulfilled even with a mobile portable terminal (such as PDA) or a portable telephone set.

Particularly, in mobile environments at a low communication rate compared to the communication rate (of several MHz to several ten MHz) in fixed environments such as ADSL, CATV, optical cable, etc., the usual large capacity data communication is heavy, and high rate communication is difficult. According to the present invention, no such problem arises even in such a case. The conventional communication via the internet network, is executed as mutual communication through the host personal computer side process and the client personal computer side process, and the data transfer rate may be reduced due to communication environments in packet communication. Therefore, even when the host personal computer side CPU operation is executed at a super-high rate, an overall high rate processing characteristics can not be obtained unless client personal computer side process, the CPU operation and write/read of data in internal memory are at high rates.

In this embodiment, on the side of the client personal computer 21 only the keyboard data input function and the data display function are executed, and basically unlike the usual personal computer process, and data process in the CPU and process of writing and reading data in and from memory are not executed. Thus, no operation rate restriction due to these processes is present. Thus, in the system according to the present invention, basically the host personal computer side process rate is the operation rate, and high rate operation characteristics compared to the prior art are maintained.

In this embodiment, instruction data are sent out from the client personal computer 21, while the quantity of data transmitted from the side of the host personal computer 31A is greatly reduced compared to the prior art with the adoption of the so-called differential data transmission system, in which only data having a difference in comparison to the immediately preceding data is sent out. This is particularly pronounced in the case of the image data transfer. While the image data quantity is usually large, the image change part in the frame cycle is not so large. Thus, with such an arrangement as to send out only the change part image data, small capacity data transmission and high rate data transmission are possible, and no stress is given to the user.

As shown above, in this embodiment the virtual performance is obtained, and only the instruction data from the client personal computer 21 and the result data from the host personal computer 31A bilaterally travel via the internet network 100. Thus, the communication data quantity is small, and even narrow band communication is not felt as heavy communication. Also, in the broad band communication, even just like from an external personal computer the sense speed of the host personal computer itself is obtainable.

In this embodiment, the data sent out from the client personal computer 21 and the data sent out from the side of the host personal computer 31A are enciphered at, for instance, 128 bits, and very high security inclusive of the above plurality of authentication processes is ensured.

Thus, by providing a restriction that the data obtained by using the host personal computer 31A is stored in the internal memory in the host personal computer 31A or in the portable memory medium 5A loaded to the portable telephone set 50 connected via the USB cable 70, it is possible to obtain uni-dimensional management of data and evade confusion due to scattering of the existing data.

In this embodiment, when a host personal computer in the company or at the own home is in use, it is controlled such that the display on its display part is locked so that data concerning the operation contents are not displayed (for instance, the display is held “off” or fixed).

When the use of the host personal computer with the client personal computer 21 is ended, a control signal for ending the operation of the host personal computer 31A and turning off the power supply is sent out. It is also possible to turn off the operation and power supply of peripheral unit (such as a printer) connected to the host personal computer.

In this embodiment, the host personal computer can be utilized at any time and in any place in the same environment so long as it is connected via the internet network or like communication line. The host personal computer need not have its power supply always “on”, it can be used by turning on the power supply, when necessary, from the external client personal computer. Likewise, the peripheral units such as a printer connected to the host personal computer can be used by turning on the power supply, and thus it is possible to save power and reinforce the security.

With the personal computer control system using portable telephone set according to the present invention according to the present invention, the following pronounced practical effects are obtainable. According to the present invention, the “ubiquitous” environment is very easily obtainable by merely loading the portable memory medium in a portable telephone set which is a daily carried tool. Also, personal computer control based on a desired application program, which is stored in the portable memory medium and provides a function as middle ware, is possible, and personal computer environments peculiar to the user are obtainable. Furthermore, at the time of ending the use of the personal computer by completing the working (operation), the process is ended with the storing of the processed or operation data in the memory medium. Thus, no data peculiar to the user remains in the universal personal computer, which is effective in the security aspect. Further, since the portable memory medium is loaded in the portable telephone set to control the client personal computer connected to the communication line such as an internet network so as to control the start of the host personal computer connected to the communication line, the host personal computer use environments can be directly utilized at any time and in any place. At this time, the power supply of the host personal computer is turned on from the “off” state under control from the client personal computer. Thus, it is possible to obtain efficient management and save power.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A personal computer control system using portable memory medium, wherein in response to loading or inserting of the portable memory medium to or in a personal computer to be used, a specific control program stored in the portable memory media for starting and controlling predetermined application program is started, a user authentication process with respect to the portable memory medium is executed, then a predetermined application program stored in the portable memory media is started, and at the end of the application program the data at the time of the end is stored in the portable memory medium.

2. The personal computer control system using portable memory medium according to claim 1, wherein the predetermined application program is installed in the personal computer to be utilized.

3. The personal computer control system using portable memory medium according to claim 1, wherein the predetermined application program is installed in a different personal computer from the personal computer to be utilized, connected via a communication medium.

4. The personal computer control system using portable memory medium according to claim 1, wherein the predetermined application program is prepared in a server connected via the internet.

5. The personal computer control system using portable memory medium according to claim 1, wherein the portable memory medium has a port lock function.

6. The personal computer control system using portable memory medium according to claim 1, wherein the specific control program is arranged to prohibit operation by copying in a different memory medium.

7. The personal computer control system using portable memory medium according to claim 1, wherein the password for the authentication is enciphered.

8. The personal computer control system using portable memory medium according to claim 1, wherein as soon as start is executed with the specific control program, unlike the desk top display in the personal computer to be used, a work table including icons of application program controlled by the specific control program is displayed, and the personal computer operation is executed by icon operation on the work table.

9. The personal computer control system using portable memory medium according to claim 1, wherein when the portable memory medium is removed from the personal computer during the personal computer operation, the operation data at this time is stored in the portable memory medium on the basis of an instruction from the user.

10. The personal computer control system using portable memory medium according to claim 1, wherein the portable memory medium is a USB memory, a CD, a DVD, a MO disc, a flash memory, a memory card or a hard disc.

11. A portable memory medium capable of being loaded in a personal computer to be used, wherein specific control programs stored in the portable memory media for starting and controlling predetermined application program, operating a predetermined application program stored in the portable memory media through a user authentication process with respect to the portable memory medium and storing data at the end time of operation of the application program.

12. The portable memory medium according to claim 11, wherein a port lock function is provided.

13. The portable memory medium according to claim 11, wherein the specific control programs are arranged to prohibit operation by copying in a different memory medium.

14. The portable memory medium according to claim 11, wherein the password for the authentication is enciphered.

15. The portable memory medium according to claim 11, wherein a program is provided that with the start executed on the basis of the specification control program, unlike the desk top display of the personal computer to be utilized, a work table including icons for application program controlled by the specific control programs is displayed, and the personal computer operation is executed with icon operation on the work table.

16. The portable memory medium according to claim 11, wherein a program is provided that when the portable memory medium is removed from the personal computer during the personal computer operation, the operation data at this time is stored in the portable memory medium on the basis of an instruction from the user.

17. The portable memory medium according to claim 11, wherein the portable memory medium is a USB memory, and, a flash memory, a memory card or a hard disc.

18. A personal computer control system using portable memory medium for controlling a host personal computer connected via a communication line from a client personal computer connected to the communication line, wherein:
in response to the loading, in the client personal computer, of a portable memory medium, which the user is allowed by authentication to use, a predetermined program of the client personal computer is started for starting and controlling the host personal computer.

19. A personal computer control system using portable memory medium for controlling a host personal computer connected to a communication line from a client personal computer connected to the communication line, wherein:
in response to the loading, in the client personal computer, of a portable memory medium, which the user is allowed by authentication to use, a predetermined program of the client personal computer is started, the state of the host personal computer is monitored, when the power supply thereof is “off”, the power supply is turned on to start and control the host personal computer.

20. The personal computer control system using portable memory medium according to claim 18, wherein data exchanged between the client personal computer and the host personal computer are enciphered.

21. The personal computer control system using portable memory medium according to claim 18, wherein the data sent out from the client personal computer is instruction data inputted from an input means, and data sent out from the host personal computer is differential data with respect to immediately preceding sent-out data.

22. The personal computer control system using portable memory medium according to claim 18, wherein at the time of ending the use of the host personal computer the final process data is stored in the portable memory medium.

23. The personal computer control system using portable memory medium according to claim 18, wherein the start of the host personal computer is made possible after completion of authentication in the portable memory medium, authentication in the client personal computer and authentication in the host personal computer.

24. The personal computer control system using portable memory medium according to claim 18, wherein the portable memory medium is either a USB memory, a NO disc, a flash memory, a memory card or a floppy disc,

25. The personal computer control system using portable memory medium according to claim 18, wherein the client personal computer is a portable terminal.

26. A portable memory medium, wherein a program is stored for executing, in response to the loading in the client personal computer, a process of checking whether the use by a particular user is allowed and a process of prescribing an operation of controlling the host personal computer connected via a communication line.

27. A portable memory medium, wherein a program is stored for executing, in response to loading in a client personal computer, a process of checking whether use by a particular user is allowed, a process of monitoring the state of host personal computer connected via a communication line, a process of turning on the power supply of the host personal computer when in the “off” state, and a process of prescribing start and control operations executed after the power supply has been turned on.

28. The portable memory medium according to claim 26, wherein the portable memory medium is a USB memory, a MO disc, a flash memory, a memory card or a floppy disc.

29. A personal computer control system using portable telephone set, wherein the portable telephone set is loaded with a portable memory medium in which control program of a personal computer operation is stored and a personal computer are connected via a USB cable to the portable telephone set, and the personal computer operation is controlled on the basis of programs stored in the portable memory medium.

30. The personal computer control system using portable telephone set according to claim 29, wherein a predetermined application program for the personal computer is stored in the portable memory medium.

31. The personal computer control system using portable telephone set according to claim 29, wherein the predetermined application programs are prepared in a server connected via the internet to the personal computer.

32. The personal computer control system using portable telephone set according to clam 29, wherein the access to the portable memory medium during use of the personal computer is prohibited.

33. The personal computer control system using portable telephone set according to claim 29, wherein at the time of ending the use of the personal computer the operation data are stored only in the portable memory medium.

34. A personal computer control system using portable telephone set, wherein a portable telephone set, in which a portable memory medium with personal computer operation control programs stored therein, and a personal computer are connected via a USB cable to each other, the personal computer operation is controlled on the basis of programs stored in the portable memory medium, and a host personal computer connected via a communication line to the personal computer is started and controlled.

35. The personal computer control system using portable telephone set according to claim 34, wherein in response to the loading of the portable memory medium in the portable telephone set, a predetermined program of the personal computer is started, the state of the host personal computer is monitored, and the power supply thereof is turned on when in the “off” state, thereby starting and controlling the host personal computer.

36. The personal computer control system using portable telephone set according to claim 34, wherein the data exchanged between the personal computer and the host personal computer are enciphered.

37. The personal computer control system using portable telephone set according to claim 34, wherein the data sent out from the client personal computer is instruction data inputted from an input means, and the data sent out from the host personal computer is differential data with respect to the immediately preceding sent-out data.

38. The personal computer control system using portable telephone set according to claim 34, wherein at the end of use of the host personal computer, the final process data is stored in the portable memory medium or in the host personal computer.

39. The personal computer control system using portable telephone set according to claim 34, wherein the portable memory medium is either an SD card, a memory stick flash memory or a USB memory.

40. The personal computer control system using portable telephone set according to claim 34, wherein the portable memory medium has a common format data arrangement for permitting signal processes in both the portable telephone set and the personal computer.

41. A portable telephone set comprising a loading part, in which a portable memory medium with personal computer operation control programs stored therein is loaded, and a USB cable connection port for connection to the personal computer, the program being started in response to the loading of the portable memory medium.

42. The portable telephone set according to claim 41, wherein in the portable memory medium stored are predetermined application programs for the personal computer.

43. The portable telephone set according to claim 41, wherein at the end of the personal computer control, the operation data are stored in the sole portable memory medium.

44. The portable telephone set according to claim 41, wherein in response to the loading of the portable memory medium in the portable telephone set, the state of the host personal computer connected via a communication line to the personal computer is monitored under control of the personal computer, and the host personal computer is started and controlled after turning on its power supply when in the “off” state.

45. The portable telephone set according to claim 41, wherein the portable memory medium is an SD card, a memory stick flash memory or a USB memory.
